(19) United States
(12) Patent Application Publication
(10) Pub. No.: US 2025/0184055 A1
(43) Pub. Date: Jun. 5, 2025

(54) Enhancement of Code-Division Multiplexing Design for Demodulation Reference Signals

(71) Applicant: Fraunhofer-Gesellschaft zur Förderung der angewandten Forschung e.V., MÜNCHEN (DE)

(72) Inventors: Sutharshun Varatharaajan, Erlangen (DE); Marcus Grossmann, Erlangen (DE); Markus Landmann, Erlangen (DE)

(73) Assignee: Fraunhofer-Gesellschaft zur Förderung der angewandten Forschung e.V., MÜNCHEN (DE)

(21) Appl. No.: 18/841,213

(22) PCT Filed: Feb. 23, 2023
(86) PCT No.: PCT/EP2023/054618

§ 371 Date: Aug. 23, 2024

(30) Foreign Application Priority Data
Feb. 23, 2022 (EP) 22158125.9
Jul. 6, 2022 (EP) 22183368.4

(51) Int. Cl. H04L 5/00

(52) U.S. Cl. CPC H04L 5/0016; H04L 5/0023; H04L 5/0051

(57) ABSTRACT

A communication device for generating a demodulation reference signal (DMRS) may be configured to generate and map a bit sequence to a first sequence and also obtain a second sequence for a port of the DMRS. The first and second sequences may be mapped to DMRS resource elements of a physical channel for the port. To map the first and second sequences, the communication device may be configured to multiply entries of the first sequence, element-by-element, with entries of the second sequence. A resulting real- or complex-valued symbol or baseband amplitude sequence may be mapped to a subset of DMRS resource elements for port from a set of resource elements associated with the DMRS in one or more physical resource blocks (PRBs) of the physical channel. The subset of DMRS resource elements associated with port may all be present in a single PRB or in at least two different PRBs.

### TECHNICAL FIELD

The present disclosure relates to the field of wireless communications, and in particular, to methods and apparatuses for demodulation reference signal (DMRS) design suitable for 5G.

### BACKGROUND

The radio access technology (RAT) in fifth generation (5G) mobile communications systems, also known as 5G new radio (NR), provides a higher level of performance and flexibility than the previous generations of mobile communications systems. 5G mobile communications has been driven by the need to provide ubiquitous connectivity for applications as diverse as automotive communication, remote control with feedback, video downloads, as well as data applications for Internet-of-Things (IoT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

The wireless communication network system may be any single-tone or multicarrier system using frequency-division multiplexing, like the orthogonal frequency-division multiplexing (OFDM) system, the orthogonal frequency-division multiple access (OFDMA) system, or any other Discrete Fourier Transform (DFT) based signal with or without cyclic prefix (CP), e.g., DFT-spread OFDM (DFT-s-OFDM). Other waveforms, like non-orthogonal waveforms for multiple access, e.g., filter-bank multicarrier (FBMC), generalized frequency division multiplexing (GFDM) or universal filtered multi carrier (UFMC), may also be used. The wireless communication system may operate, e.g., in accordance with the LTE-Advanced Pro standard, the 5G or NR (New Radio) standard or any other standard using any of the aforementioned waveforms.

For data transmission, a physical resource grid may be used. The physical resource grid may comprise resource blocks (RBs) and symbols, that in turn comprise a set of resource elements (REs), to which various physical channels and physical signals are mapped. For example, the physical channels may include the physical downlink, uplink and/or sidelink (SL) shared channels (respectively, abbreviated as PDSCH, PUSCH, PSSCH) carrying user specific data, also referred to as downlink, uplink or sidelink payload data, the physical broadcast channel (PBCH) carrying, for example, a master information block (MIB) and a system information block (SIB), the physical downlink, uplink and/or sidelink control channels (respectively, abbreviated as PDCCH, PUCCH, PSCCH) carrying, for example, the downlink control information (DCI), the uplink control information (UCI) or the sidelink control information (SCI). For the uplink, the physical channels may further include the physical random-access channel (PRACH or RACH) used by UEs for accessing the network once a user equipment (UE) is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. In 5G, each slot consists of 14 OFDM symbols or 12 OFDM symbols based on normal CP and extended CP, respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a UE whether an OFDM symbol is downlink, uplink or flexible.

The term ‘higher layer’ in the following, when used in isolation, denotes any communication layer above the physical layer in the protocol stack. When the term is used in connection with a specific layer, it denotes any communication in the protocol stack above said layer.

The term serving cell and carrier component (CC) may be used interchangeably in this disclosure as a serving cell configured for a UE and is usually a separate physical carrier centered around a particular carrier frequency. Depending on the frequency of a component carrier/serving cell, the size of the cell and the beamformed reference signals may vary.

The term ‘PDxCH’ or ‘PDXCH’ may indicate either the physical downlink shared channel (PDSCH) or the physical downlink control channel (PDCCH), while ‘PUxCH’ or ‘PUXCH’ may indicate either the physical uplink shared channel (PUSCH) or the physical uplink control channel (PUCCH). The term ‘PxxCH’ or ‘PXXCH’ may denote a PDSCH, a PDCCH, a PUSCH, a PRACH, a PBCH, a PSSCH, or a PSCCH.

The phrase ‘fixed/predetermined/provided in the specifications’ in this invention disclosure may mean the following: one or more rules and/or methods and/or particulars regarding certain parameter(s) are provided in the standard specifications that the UE and/or any network node is supposed to follow or implement.

The term ‘configured’ may mean the following: one or more rules and/or methods and/or particulars regarding one or more parameters as provided in the standard specifications that the UE is supposed to follow or implement are provided to the UE by one or more network entities, e.g., via higher layer signaling, like radio resource control, RRC, signaling.

The DeModulation Reference Signal (DMRS) is a reference signal used for the coherent demodulation of a physical channel transmission (for e.g., a physical downlink shared channel (PDSCH), a physical downlink control channel (PDCCH), a physical uplink shared channel (PUSCH), physical broadcast channel (PBCH), a physical random access channel (PRACH), a physical sidelink shared/control channel (PSSCH/PSCCH) or a physical uplink control channel (PUCCH)). It is transmitted together with each of the channels mentioned above and the design of the DMRS for each one of them may be different.

### SUMMARY

It is an object of some embodiments herein to provide a solution in terms of methods and apparatuses for generating a demodulation reference signal (DMRS) comprising one or more ports for a transmission of a physical channel.

According to a first aspect of some embodiments herein, there is provided a method performed by a communication device, for generating a DMRS comprising one or more ports for a transmission of a physical channel. The method comprises generating and mapping a bit sequence to a first sequence r(q), the first sequence being a real- or complex-valued sequence. The method further comprises obtaining a second sequence c_{f}(\tilde{k}), where \tilde{k}=0, 1, . . . , L−1 for a port p of the DMRS. The second sequence may be or comprise at least one of a column or a row of a Discrete Fourier Transform (DFT)-based matrix such as a DFT matrix or an Inverse DFT matrix of size L×L, a column or a row of a Discrete Cosine Transform (DCT)-based matrix of size L×L, a column or a row of a Hadamard matrix of size L×L, or a column or a row of any other orthogonal or unitary matrix of size L×L. The method further comprises mapping the first and second sequences to L DMRS resource elements of the physical channel for said port p. In this regard, mapping the first and second sequences comprises multiplying L entries of the first sequence r(q), element-by-element, with the L entries of the second sequence, c_{f}(\tilde{k}), for the port p, to obtain a resulting real- or complex-valued symbol or baseband amplitude sequence d(i), and mapping the resulting real- or complex-valued symbol or baseband amplitude sequence d(i) to a subset of L DMRS resource elements for the port p from a set of resource elements associated with the DMRS in one or more physical resource blocks (PRBs) of the physical channel. The subset of L DMRS resource elements associated with the port p are all present in a single PRB or in at least two different PRBs.

According to a second aspect of some embodiments herein, there is provided another method performed by a communication device for receiving a physical channel with a demodulation reference signal (DMRS) comprising one or more ports. The method comprises processing the received physical channel with the DMRS. The DMRS for the physical channel is generated by generating and mapping a bit sequence to a first sequence r(q), where the first sequence is a real- or complex-valued sequence. Additionally, the physical channel is generated by obtaining a second sequence c_{f}(\tilde{k}), where \tilde{k}=0, 1, . . . , L−1 for a port p of the DMRS. The second sequence c_{f}(\tilde{k}) is or comprises at least one of a column or a row of a Discrete Fourier Transform (DFT)-based matrix such as a DFT matrix or an Inverse DFT matrix of size L×L, a column or a row of a Discrete Cosine Transform (DCT)-based matrix of size L×L, a column or a row of a Hadamard matrix of size L×L, or a column or a row of any other orthogonal or unitary matrix of size L×L. The DMRS for the physical channel is generated by mapping the first and second sequences to L DMRS resource elements of the physical channel for the port p, which comprises multiplying L entries of the first sequence r(q), element-by-element, with the L entries of the second sequence c_{f}(\tilde{k}) for the port p to obtain a resulting real- or complex-valued symbol or baseband amplitude sequence d(i), and mapping the resulting real- or complex-valued symbol or baseband amplitude sequence d(i) to a subset of L DMRS resource elements for the port p from a set of resource elements associated with the DMRS in one or more physical resource blocks (PRBs) of the physical channel. The subset of L DMRS resource elements associated with the port p are all present in a single PRB or in at least two different PRBs.

According to third aspect of some embodiments herein, there is provided a communication device for generating a demodulation reference signal (DMRS) comprising one or more ports for a physical channel. The communication device comprises a processor and a memory containing instructions executable by the processor, whereby the communication device is configured to generate and map a bit sequence to a first sequence r(q), the first sequence being a real- or complex-valued sequence. The communication device is further configured to obtain a second sequence c_{f}(\tilde{k}), where \tilde{k}=0, 1, . . . , L−1 for a port p of the DMRS. The second sequence c_{f}(\tilde{k}) is or comprises at least one of a column or a row of a Discrete Fourier Transform (DFT)-based matrix such as a DFT matrix or an Inverse DFT matrix of size L×L, a column or a row of a Discrete Cosine Transform (DCT)-based matrix of size L×L, a column or a row of a Hadamard matrix of size L×L, or a column or a row of any other orthogonal or unitary matrix of size L×L. The communication device is further configured to map the first and second sequences to L DMRS resource elements of the physical channel for the port p, which comprises being configured to multiply L entries of the first sequence r(q), element-by-element, with the L entries of the second sequence c_{f}(\tilde{k}) for the port p to obtain a resulting real- or complex-valued symbol or baseband amplitude sequence d(i), and map the resulting real- or complex-valued symbol or baseband amplitude sequence d(i) to a subset of L DMRS resource elements for the port p from a set of resource elements associated with the DMRS in one or more physical resource blocks (PRBs) of the physical channel. The subset of L DMRS resource elements associated with the port p are all present in a single PRB or in at least two different PRBs.

The communication device is configured to or is operative to perform any one of the subject-matter of methods described herein. The communication device may be a network node or a UE.

There is also provided a computer program comprising instructions which when executed by the processor of the communication device to cause the processor to carry out the methods described herein.

A carrier is also provided containing the computer program wherein the carrier is one of a computer readable storage medium, an electronic signal or a radio signal.

Additional embodiments of the present invention will be presented in the detailed description.

An advantage with some embodiments of the present disclosure is to enhance the 5G NR DMRS configuration types.

Further, with the variations of mapping enabled, DMRS interference mitigation between users based on similar pseudorandom binary sequences (first sequences r(q)) is a potential advantage of some methods. Moreover, with a flexible CDM sequence size L introduced in some methods, the use of various new real and complex-valued CDM sequences other than orthogonal cover codes is made possible. This advantage comes with very little penalty as it preserves the peak-to-average-power ratio of the transmitted OFDM waveform and also increases the number of DMRS ports for a physical channel that can be multiplexed in a transmission without increasing the overhead of the time and frequency domain resources allocated for DMRS. Thus, some methods are superior to the 5G NR DMRS configuration in terms of practical utility and technical novelty.

### BRIEF DESCRIPTION OF THE DRAWINGS

FIG. 1 is a simplified block diagram of a PxxCH transmit processing unit until spatial precoding

FIG. 2 illustrates single and double symbol DMRS resource element positions for DMRS configuration Type 1

FIG. 3 illustrates single and double symbol DMRS resource element positions for DMRS configuration Type 2

FIG. 4 depicts DMRS configuration Type 1 with single symbol DMRS for antenna ports 1000, 1001 in CDM group 0 and antenna ports 1002, 1003 in CDM group 1

FIGS. 5A-5B depicts DMRS configuration Type 1 with double symbol DMRS for 8 antenna ports

FIGS. 6A-6B illustrates DMRS configuration Type 2 with double symbol DMRS for 12 antenna ports

FIG. 7 shows different examples of DMRS sequence and RE mapping for L=4 (a), L=6 (b) and L=4 (c) respectively

FIG. 8 shows different examples of DMRS sequence and RE mapping for L=4 (a), L=4 (b), L=6 (c) and L=8 (c) respectively

FIG. 9 illustrates different examples of DMRS sequence and RE mapping for L=6 (a), and L=9 (b) respectively

FIG. 10 shows different examples of DMRS sequence and RE mapping for L=3 (a), L=4 (b), and L=6 (c) respectively

FIG. 11 illustrates a flowchart of a method performed by a communication device according to some embodiments herein

FIG. 12 illustrates a simplified block diagram of a communication device according to some embodiments herein.

### DETAILED DESCRIPTION

In the following is presented a detailed description of the exemplary embodiments in conjunction with the drawings, in several scenarios, to enable easier understanding of the solution(s) described herein.

As previously mentioned, in this disclosure, methods, and apparatuses for the enhancement of the code-division-multiplexing (CDM) design for DMRS ports are provided. For a given DMRS configuration, the number of layers that can be multiplexed is increased without increasing the DMRS overhead. A ‘densification’ of the DMRS port multiplexing is achieved, which is helpful for use-cases like enhanced mobile broadband, especially in high Signal to Noise Ratio (SNR) scenarios to increase cell and UE throughput. In addition, methods for interleaved and non-interleaved application of the CDM are introduced, which present a novel method of DMRS sequence mapping.

In the following, the design of the DMRS for the PDSCH is presented.

A PDSCH transmission in a given slot spans N_{sym}^{PDSCH} OFDM symbols (referred to as ‘symbols’ hereafter) and N_{sc}^{PDSCH} subcarriers. The REs in the time-frequency grid in which the DMRS is transmitted are embedded in the allocation provided for the PDSCH. For a given PDSCH allocation in a 5G NR slot in the physical layer frame structure, the DMRS allocation for the PDSCH is determined by multiple DMRS parameters. Typically, PDSCH DMRS is available in one or more ‘positions’ in the slot comprising the PDSCH wherein each ‘position’ comprises DMRS REs in one or two consecutive symbols. The DMRS configuration of a physical channel is provided to the UE by a network node via a higher layer (e.g., Radio Resource Control). The following parameters determine the allocation of the DMRS, and the network provides them to the UE (e.g., via a higher layer configuration-either provided in the DMRS configuration or separately):
Mapping type: the first symbol with DMRS in the first position is determined by the PDSCH mapping type. Other parameter(s) involved in the determination of the first position may be the starting symbol of the PDSCH and the number of symbols allocated for the PDSCH in the slot.
DMRS additional position and maximum length: the numbers of positions in which the DMRS is transmitted is determined by the DMRS additional position. At each ‘position’, l_{DMRS}=1 or 2 symbols comprising DMRS REs are found—the value of l_{DMRS}, i.e., length of DMRS, is partly determined by the value ‘maxLength’ in the DMRS configuration. If the value of maxLength is configured as 1, l_{DMRS} can only take a value of 1. If the value of maxLength is configured as 2, l_{DMRS} can take a value of 1 or 2 and the exact value is indicated via a lower layer (e.g., PHY-layer). If the length of DMRS is 1, it is called single-symbol DMRS and if the length is 2, it is called double-symbol DMRS. The length of the DMRS may also be referred to as the number of front-load symbols of the DMRS.
DMRS type: the number of resource elements (REs) and indices of the REs in a symbol that comprises DMRS are determined by the DMRS type. The DMRS type may also influence the values of some of the parameters above.

The above parameters may also be applicable for the PUSCH. In the case of the PUCCH, the PDCCH or other physical channels, a different set of parameters may be involved. The DMRS is inserted in the time-frequency grid corresponding to each data layer or data stream. Each data stream/layer corresponds to a DMRS port. Therefore, the terms ‘layer’, ‘stream’ (of data/payload of a physical channel) and ‘DMRS port’ may be used interchangeably in this invention disclosure. A PDSCH is said to be transmitted on its associated DMRS ports. A DMRS port is given a port number and the position of the DMRS resource elements, and the complex baseband amplitude mapped to the DMRS resource elements in the port are determined by the port number. The complex baseband amplitude that is mapped to the DMRS resource elements is typically generated by a sequence of bits (which are typically pseudo random, for e.g., Gold codes, Zadoff-Chu sequence, low-peak-to-average-power-ratio (low-PAPR) sequences etc.) that is then modulated into Quadrature Phase Shift Keying (QPSK) symbols. In certain scenarios (especially in Frequency Range 2 (FR2), i.e., frequencies above 6 GHZ), there may be phase-tracking reference signals (PTRS) associated with some DMRS ports and PTRS resource elements may also be inserted in the layers corresponding to the associated DMRS ports during resource mapping. PTRS is used in tracking the phase distortions at the transmitter which are prominent in FR2. PTRS transmission may be configured via a higher layer.

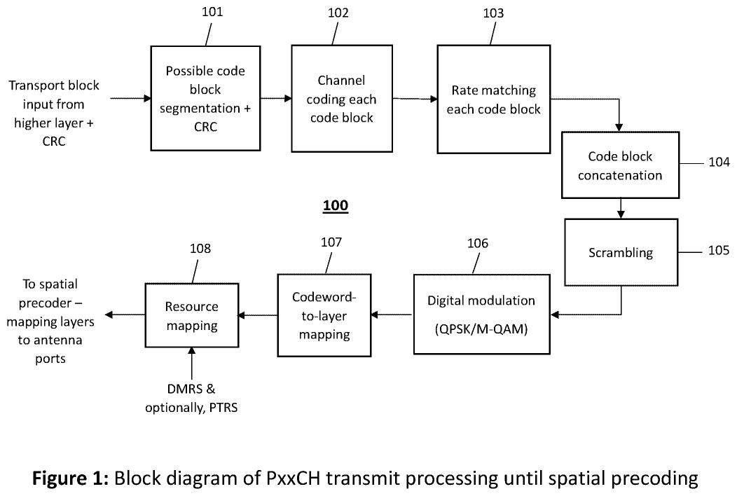

Referring to FIG. 1, there is illustrated a block diagram 100 of a PxxCH transmit processing until spatial precoding as described below.

A physical layer data or control transmission, until it is mapped to the layers and allocated to the time-frequency grid in a slot, may comprise the following sequence of processing with reference to FIG. 1:
Obtaining the bits from a higher layer for the transport block(s) to be transmitted, with the possibility of more than one transport blocks depending on the number of layers
101 Attaching a cyclic redundancy check (CRC) to each transport block and possible segmentation of the transport block into code blocks and if segmented, attaching CRC to each segmented code block
102-103 Channel coding and rate matching (e.g., low density parity check (LDPC) codes, in the case of 3GPP 5G NR physical shared channel(s), polar codes in the case of 3GPP 5G NR physical control channel(s)) of each code block individually according to the code rate p and the number of available data REs set for the transmission
104 Concatenation of the rate-matched coded blocks into a single vector forming a codeword corresponding to each transport block
105 Performing a scrambling operation on the output of the code concatenation block 104
106 Digital modulation (M-QAM) of the codeword bits according to the modulation order M set for the transmission
107 Mapping of the modulated codeword(s) to N_{L} layers set for the transmission
108 The layers are mapped to the respective time-frequency grids according to the resource allocation along with the DMRS resource elements for the N_{L} DMRS ports corresponding to the N_{L} layers. Optionally, some layers may also comprise PTRS depending on network configuration.

The time-frequency grids after the resource mapping 108 comprise the time-frequency-grid-mapped layers to be transmitted and a spatial precoder may map the layers to the antenna ports at the transmitter. The spatial precoding for a certain point in the time-frequency-grid may be different from the spatial precoding used for a different point in the time-frequency-grid.

The transmit processing for a physical uplink/downlink control channel is similar, in terms of the order of some of the building blocks of the transmit processing chain, such as the transport block CRC attachment, coding, rate-matching, digital modulation, resource mapping, spatial precoding, etc. The details of the processing, however, may differ.

The DMRS and the associated physical channel are precoded and the precoding matrix/matrices used is/are transparent to the receiver, i.e., the receiver, typically, does not know (and in many cases, does not need to know) the precoding and it estimates the effective channel between the DMRS ports and the receiving ports at the receiver with the transmitted DMRS.

In the following, the functionality of each of the above-mentioned variables in the DMRS configuration is briefly reviewed.

### DMRS Ports

As described earlier, each DMRS port corresponds to a data layer transmitted. Therefore, for a PxxCH transmission comprising N_{L} layers, there are N_{L} DMRS ports associated with it. In this disclosure, the transmission of a PxxCH on one or more DMRS port(s) may mean that the PxxCH transmission or a part, i.e., one or more data layers/streams of the PxxCH transmission is/are associated with the said DMRS ports. The DMRS ports are numbered as follows for PUSCH and PDSCH:
1000 to 1007 for DMRS configuration type 1 of PDSCH and 0 to 7 for DMRS configuration type 1 of PUSCH
1000 to 1011 for DMRS configuration type 2 of PDSCH and 0 to 11 for DMRS configuration type 2 of PUSCH

Depending on the port number, each port can be classified into a specific code-division-multiplexing (CDM) group. There are 2 CDM groups in configuration type 1 numbered 0 and 1, and 3 CDM groups in configuration type 2 numbered 0, 1 and 2. The positions of the resource elements in the time-frequency grid occupied by ports belonging to the same CDM group are the same. The positions of the resource elements in the time-frequency grid occupied by two different DMRS ports belonging to two different CDM groups are entirely distinct, i.e., there is no overlap in the positions of the resource elements in the time-frequency grid for two different DMRS ports belonging to two different CDM groups. Therefore, the DMRS resource element positions in two different CDM groups are time and/or frequency division multiplexed (TDMed and/or FDMed). A sequence of complex values is generated from a modulation (for e.g., QPSK) of pseudo-random sequences and then mapped to the DMRS resource elements. Within a CDM group, the base-sequence of complex values used for each port is the same, but the final value mapped to a resource element in a given port is determined by an orthogonal cover code (OCC)—the value from the base-sequence of complex values corresponding to the resource element is multiplied by +1 or by −1 based on the port number and the resource element position in the time-frequency grid. By this method, the sequence of complex amplitudes mapped to the resource elements in a given port within a CDM group is orthogonalized with the sequence of complex amplitudes mapped to any other port within the same CDM group. The resource element positions for various DMRS configurations, the use of the orthogonal cover code (OCC) in multiplexing the ports, the DMRS density, etc. are discussed in the following and otherwise herein.

### DMRS Configuration Type and Allocation

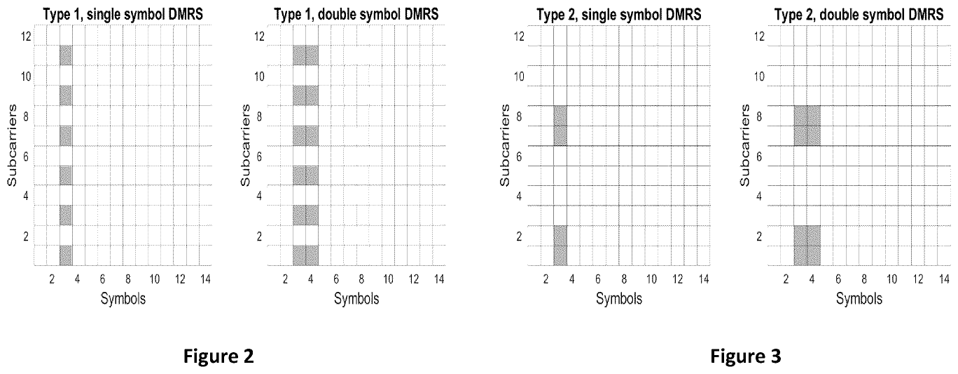

A DMRS configuration type determines the density of DMRS allocation in the frequency domain. In particular, DMRS configuration type 1 occupies 50% and DMRS configuration type 2 occupies 33.3% of the REs of the OFDM symbols carrying DMRS. In other words, for configuration type 1, every 2nd RE is used to carry DMRS, while in configuration type 2 every 3rd pair of REs are allocated to DMRS. Orthogonal Cover Code (OCC) is used for the code-division-multiplexing of the ports within a given CDM group. The OCC is a sequence of entries comprising +1 and/or −1 that is multiplied with the DMRS sequence of complex baseband amplitudes. One example allocation of DMRS for configuration type 1, for the case of single and double symbol DMRS, is provided in FIG. 2. Similarly, the allocation for DMRS configuration type 2, for single and double symbol DMRS is provided in FIG. 3.

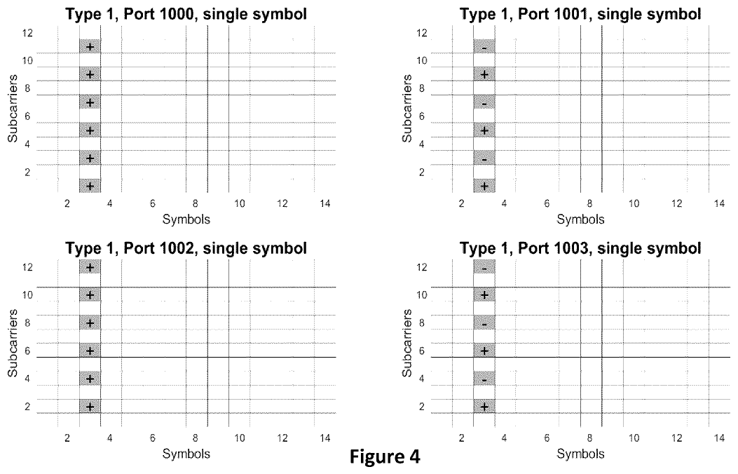

FIG. 4 shows an example DMRS configuration type 1, for single symbol DMRS and the case where four antenna ports (antenna ports 1000, 1001, 1002, and 1003 of PDSCH DMRS) are multiplexed. Here, antenna ports 1000 and 1001 use CDM group 0 (top configuration), while antenna ports 1002 and 1003 use CDM group 1 (bottom configuration) and are frequency multiplexed with antenna ports 1000 and 1001. The ‘+’ and ‘−’ mentioned in the DMRS resource elements denote the orthogonal cover code entry (+1 or −1) that is applied/mapped to said DMRS resource element.

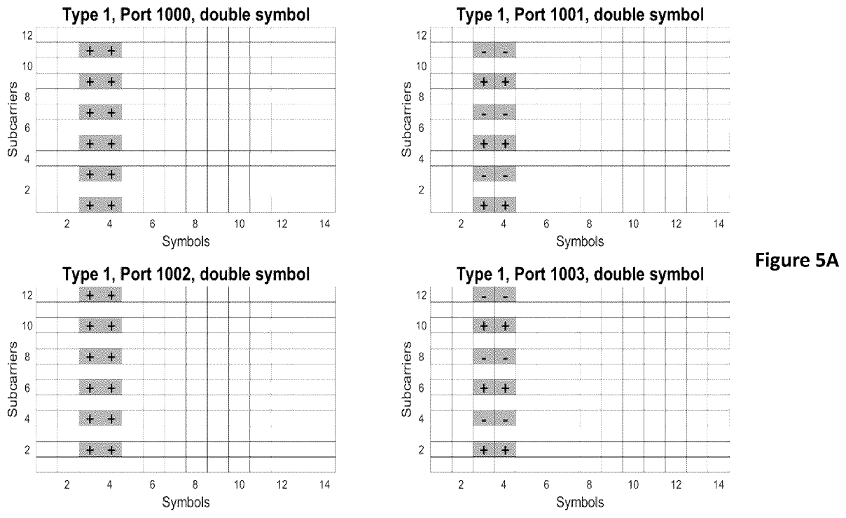

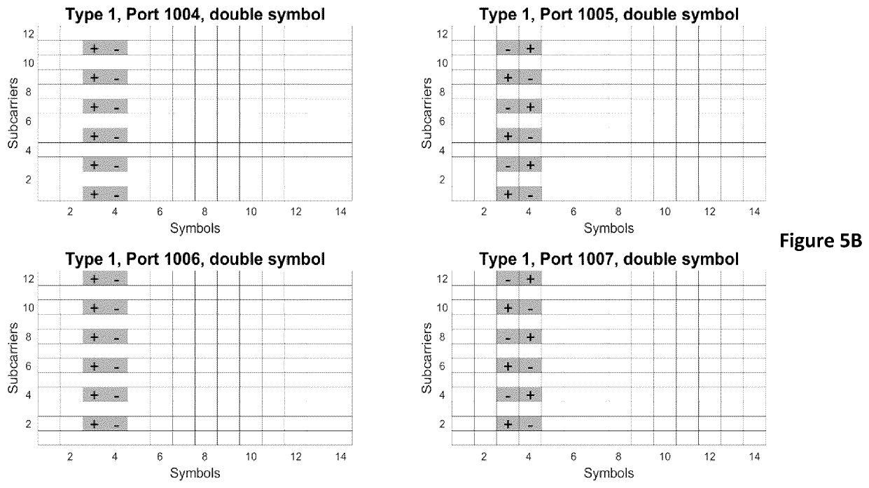

If additional ports are to be multiplexed in DMRS configuration type 1, which comprises only 2 CDM groups, an additional symbol would be required for the OCC to orthogonalize the extra port(s) added to a CDM group. FIGS. 5A-5B show an example DMRS allocation used in the case of configuration type 1 with 8 ports (1000-1007) and double symbol DMRS. At least 2 DMRS symbols are required to support 8 port transmissions.

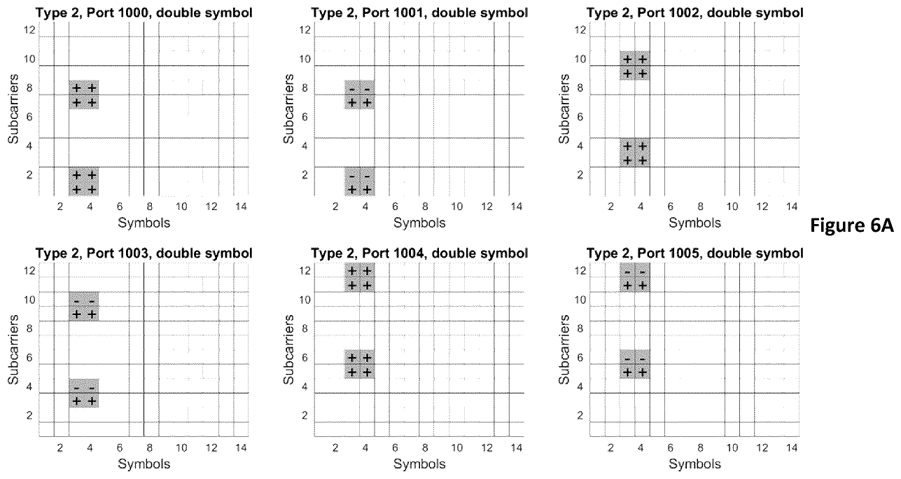

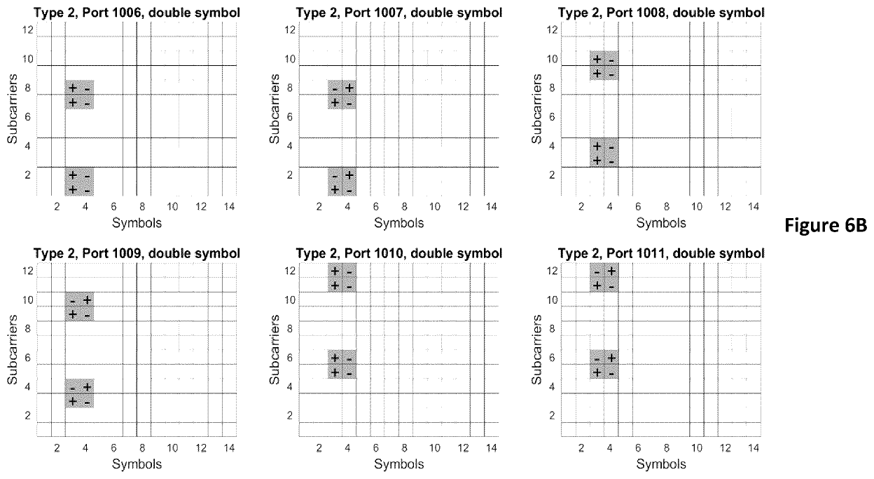

For DMRS configuration type 2, up to 12 DMRS ports (1000-1011) can be supported. A total of 3 CDM groups are available in DMRS configuration type 2-CDM groups 0, 1 and 2. Each CDM group can support up to 2 ports with single symbol and up to 4 ports with double symbol. An example allocation of DMRS configuration type 2, double symbol DMRS with 12 DMRS ports is shown in FIGS. 6A-6B. At least 2 DMRS symbols are required to support the 12 port transmissions.

### PxSCH Mapping Type

The mapping type used for PDSCH or PUSCH may affect the time-domain allocation of DMRS symbols. For PDSCH, when mapping Type A is configured, considering an indexing of symbols in a slot starting with 0, the corresponding PDSCH symbols in the configured slot can start from symbol 0 to symbol 3. In this case, the DMRS symbol can be located either in symbol 2 or symbol 3. In the NR specifications, the higher layer parameter “dmrs-TypeA-Position” is used to indicate the first symbol used by DMRS. On the other hand, when mapping type B is configured, the DMRS symbol is located in the first symbol of resource allocation. This is sometimes referred to as “front loaded” DMRS configuration, because DMRS is at the front of the transmission. This mapping type is typically used in mini-slot-based allocation that is widely used in low latency communications. The packet sizes in such scenarios are usually smaller and they are conveyed over a reduced number of symbols within a slot. In addition, there may be more than one PDSCH/PUSCH transmission occasions in the case of mapping type B within a slot.

### DMRS Additional Positions

For a given DMRS configuration or mapping type the configuration of additional DMRS positions is possible. This is typically useful when the resource allocation occupies a wide range of symbols. For the channel to be tracked over a wider array of symbols, DMRS in additional positions that are spread across the allocated symbols of the PDxCH/PUxCH would be required. The number of additional DMRS symbols together with their respective positions is configured via the higher layer parameter “dmrs-AdditionalPosition” and is determined based on the duration of the transmission.

DMRS with Transform Precoding and Overlap of DMRS with Data and Other Signals

If a RE is assigned to DMRS, it is typically not assigned with any other data or signal. This means that if a certain position in a time-frequency grid (a resource element) is assigned for DMRS in any of the ports, then no other signal or data is assigned to that position in the time-frequency grid in any of the other ports. In the case of DFT-s-OFDM, the data resource elements that are mapped to each OFDM symbol are transform-precoded (i.e., DFT-spread) before they are mapped. If a symbol comprises of DMRS resource elements, then there is no data or any other signal included in the symbol (i.e., no data or any other signal is included in the resource elements that do not carry DMRS in the symbol). Since a low-PAPR (peak-to-average power ratio) sequence is used for DMRS with DFT-s-OFDM, multiplexing the DMRS with data is avoided as it would compromise the low-PAPR property.

### DMRS Configuration Indication

The DMRS configuration for a certain channel is provided to the UE, via a higher layer (for e.g., the radio resource control (RRC) layer of the protocol stack) by a network node. Some parameters such as port numbers, number of CDM groups without data and the number of front-loaded symbols (single or double), for the DMRS are provided via the downlink control information (DCI) with which the DMRS allocation is determined. The DMRS sequence, on the other hand, is determined by one or more of the following parameters for a given physical layer channel: scrambling ID(s), cell ID(s), PUSCH identity, number of symbols per slot, hopping ID(s), etc.

### DMRS Indication Via the Downlink Control Information for Shared Channels

As mentioned above, some DMRS parameters associated with physical channels, such as the DMRS port number(s)/index (indices), the number of CDM groups without data and the number of front-loaded symbols may additionally be provided by the downlink control information (DCI) or the sidelink control information (SCI) scheduling said channels. The downlink control information (DCI) is typically transmitted from a network node to a UE and the sidelink control information (SCI) is transmitted from a network node or a UE to another UE. The field in the control information used for this purpose is the ‘Antenna Port(s)’ or the ‘DMRS port(s)’ field. The number of DMRS port indices indicated is equal to the number of layers of the channel scheduled. The parameter ‘number of CDM groups without data’ indicates the number of CDM groups of DMRS around which the channel data should be rate-matched. For example, if the number of CDM groups without data is equal to ‘R’, then the shared channel data is rate-matched around the resource elements corresponding to DMRS CDM groups {0, . . . , R−1}. This parameter also determines the transmit power of DMRS. The number of front-loaded symbols, as explained above, determines the number of symbols occupied by DMRS at a given position for DMRS. The number of front-loaded symbols can be either 1 or 2. For higher layer parameter ‘maxLength’ configured to 2, the DCI may indicate 1 or 2 front-loaded symbols. If the value of ‘maxLength’ is configured to 1, the DCI may indicate only 1 front-loaded symbol.

It is to be noted that the terms ‘Antenna Port(s)’, ‘DMRS port(s)’ and ‘Antenna/DMRS port(s)’ may be used interchangeably in this invention disclosure. Moreover, the ‘Antenna Port(s)’ field in a DCI or SCI may also be referred to as ‘DMRS port(s)’ field or ‘DMRS/Antenna port(s)’ field in this invention disclosure.

For a DCI scheduling a DL or UL channel, the DMRS/Antenna port(s) indication field in the DCI may vary in size depending on higher layer configuration. A bit-pattern or a codepoint of the field maps to value(s) corresponding to two or three different parameters—the DMRS port index/indices to be used for the transmission of the scheduled channel, the number of CDM groups without data that is used for rate-matching the scheduled channel and the number of front-loaded symbols, in some cases (for example, when higher layer parameter ‘maxLength’ is configured to 2). In some cases (the sidelink channel(s), for instance) the DMRS/Antenna port(s) indication field may indicate just the port index/indices to be used for the transmission.

Note that a b-bit field in a DCI/SCI comprises 2^{b} codepoints or possible bit patterns. A codepoint can be denoted using the bit-pattern or the decimal-converted value of the corresponding bit-pattern. For example, in a 6-bit field, codepoint ‘9’ means that the field has a bit-pattern of ‘001001’ and codepoint ‘49’ means that the field has a bit-pattern of ‘110001’. Similarly, in a 4-bit field, codepoint ‘12’ has a bit-pattern of ‘1100’ and codepoint ‘10’ has a bit-pattern of ‘1010’.

### DMRS Ports CDM Densification Using CDM Application Change in Frequency Domain

The CDM is typically applied across adjacent symbols and/or a pair of adjacent resource elements/subcarriers in a symbol. So, two CDM ports per a pair of subcarriers and two CDM ports per a pair of symbols result in providing up to four CDMed ports for double-symbol DMRS. The extension of the CDM application from the pair of adjacent subcarriers instead to subcarrier either spread across PRBs or subcarriers that are spread across multiple combined resource element mappings/allocation (for e.g., a pair of adjacent subcarriers, a group of subcarriers that belong to a single frequency-domain-based allocation index) is provided in this present invention disclosure to improve the CDM length, ‘interleave’ or ‘spread’ the orthogonalization sequence and ‘densify’ the ports in a given CDM group.

In the following, some embodiments of the present disclosure are presented.

According to some embodiments, there is provided a method, performed by a communication device, for generating a DMRS comprising one or more ports for a transmission of a physical channel, the method comprising generating and mapping a bit sequence to a real- or complex-valued sequence r(q).

According to some embodiments, there is provided a method, performed by a communication device, for generating a DMRS comprising one or more ports for a transmission of a physical channel, the method comprising:
Generating and mapping a bit sequence to a first real- or complex-valued sequence r(q), wherein,
   the indexing q is expressed as a linear combination of a first index/variable and a second index/variable in which said both first and second indices/variables are integer valued and non-negative, and
   the sequence r(q) comprises at least L entries;
Generating a second L-length sequence c_{f}(\tilde{k}) for a port p of the DMRS comprising unit-magnitude entries that are real- or complex-valued; wherein \tilde{k} is an indexing variable; and
Mapping the first and second sequences to a subset of L DMRS resource elements of the physical channel for said port p, wherein the DMRS resource elements are associated with at least two different values of said first index/variable, and are present in one physical resource block (PRB) or across multiple PRBs associated with the physical channel.

According to some embodiments, the generation of a sequence by a device may involve the following:
Computation of at least a subset of values corresponding to the sequence based on fixed/specified rule(s) provided in the specification(s), and/or
Obtaining/retrieving at least a subset of values corresponding to the sequence provided directly in the specification(s), which may optionally be stored in the device's memory.

The indices/variables that are used to express q as a linear combination are used to segment the DMRS resource elements. The first index may be used to indicate a segment in the DMRS resource elements, and the second index may be used to indicate a DMRS resource element within a segment. The coefficients of the linear combination may determine the size of the segmentation and the order of indexing. With this method wherein the mapping of a second sequence, which is introduced for the code-division multiplexing (CDM) of ports in the DMRS, applied across different segments, an interleaving of the CDM application is possible. This also paves way for a densification of ports in a DMRS configuration.

According to some embodiments, the second index takes values that are less than or equal to a pre-determined, pre-configured or a fixed value in the specifications.

According to some embodiments, the first index takes values that are less than or equal to a value that is dependent on the number of resource blocks allocation for the physical channel and/or the DMRS associated with said physical channel (for e.g., a scalar multiple of said number of resource blocks).

In the above method, the indexing q for the sequence r(q) is expressed in terms of (or a linear combination of) two indices/integer variables n and k′.

According to some embodiments, the indexing of the first sequence r(q) is expressed as q=θ·n+φ·k′ wherein θ and φ are scalars that are non-negative integers, n and k′ are said first and second indices/integer variables respectively.

According to an embodiment, the mapping of the first and second sequences to L DMRS resource elements of the physical channel for port p comprises multiplying L entries of the first sequence, r(q), element-by-element, with the L entries of the second sequence, c_{f}(\tilde{k}), for said port p, wherein \tilde{k} is the indexing variable, and mapping the resulting real- or complex-valued symbol (or the real- or complex-valued baseband amplitude) sequence, denoted d(i), to the subset of L DMRS resource elements for port p from a set of resource elements associated with the DMRS in one or more PRBs of the physical channel.

It is to be noted that in baseband processing of a signal, a resource element (an element at a specific position in a time-frequency grid) is typically mapped to or associated with a real- or complex-valued entry/number which may be called a ‘symbol’ or ‘baseband amplitude’.

The subset of L DMRS resource elements may be:
a subset of DMRS resource elements associated with the DMRS in one or more PRBs of the physical channel,
the set of all DMRS resource elements associated with the DMRS in one or more PRBs of the physical channel.

In some examples, said subset of L DMRS resource elements associated with port p are all present in a single PRB. A simple mapping of the CDM sequence (the second sequence) to consecutive resource elements can be performed with this method.

According to an embodiment, said subset of L DMRS resource elements associated with port p are present in at least two different PRBs. At least one resource element from said L subset of DMRS resource elements may be present in a first PRB and at least one other resource element from said L subset of DMRS resource elements may be present in a PRB other than the first PRB. This gives rise to different variations of CDM mapping, as explained further below in this invention disclosure.

In some examples, the integer indices or integer variables n and k′ are defined as follows n=0, 1, . . . and k′=0, . . . , K′−1 with K′≥1. It may also be possible that one or more of the integer indices or integer variables in the above method may start from 1 instead of 0 (k′=1, . . . , K′ with K′≥2 instead of starting from 0, and/or n=1, 2, . . . instead of starting from 0).

According to some exemplary embodiments, each DMRS resource element is associated with a value n via the index of the sequence r(q), wherein q=θ·n+φ·k′, whose entry is used to compute the real- or complex-valued symbol (or complex-valued baseband amplitude) mapped to the resource element (RE). For example, for the values θ=2, φ=1 and K′=2 used for the DMRS configuration, for a DMRS RE whose complex valued symbol is computed from r(4), the associated value of n is 2.

The mapping described above for a subset of L resource elements of the DMRS is repeated to multiple different disjoint subsets of resource elements of the DMRS to obtain the DMRS for the resource elements in said port.

According to some embodiments, the index k takes a value from the following: 0, . . . , L−1.

According to some embodiments, the mapping of the L-length sequence c_{f}(\tilde{k}) to a subset of L resource elements of the DMRS, is repeated for multiple different disjoint subsets of resource elements of the DMRS in a DMRS port.

In this disclosure, for a given sequence, say s(i), of a given length, say x, the integer-valued index i takes the values 0, . . . , x−1 or 1, . . . , x. The above method may be performed by a communication device such as a UE or a network node or gNB. The communication device performs transmission of said physical channel with the associated DMRS obtained using said method of DMRS generation and/or mapping. In the case of the network node, the physical channel may be a physical control, shared or broadcast channel (for e.g., a physical downlink shared channel, physical broadcast channel or a physical downlink control channel). A communication device acting as a UE may receive said downlink transmission from the network node. It may process the physical channel transmission from the network node which may include coherent demodulation of said physical channel transmission with said DMRS (this may be performed using said DMRS). In the case of the user equipment (UE), said physical channel may be a physical control, shared or random access channel (for e.g., a physical uplink shared channel, a physical uplink control channel, a physical random access channel or any physical sidelink channel (PSSCH or PSCCH)). A network node or another user equipment may receive said transmission from the user equipment. It may process the received physical channel transmission which may include coherent demodulation of said physical channel transmission with said DMRS (this may be performed using said DMRS).

The variables θ and φ are used for controlling the ‘segmentation’ of DMRS resources, as mentioned before. The variable e controls the number of DMRS resource elements within a segment, n provides the indexing for a segment and k′ provides the indexing for the resource elements within a segment. The variable φ can provide a second level of segmentation within a segment associated with a value of θ. When it is set to one, a single level of segmentation is performed in the DMRS. The DMRS resource elements of the same segment are placed sequentially (in ascending or descending order) in the frequency domain in terms of their resource element indices (or subcarrier positions). In the proposed approach, CDM is used over various segments, where the segments are either within a PRB or spread across multiple PRBs. This approach provides multiple possibilities for spreading the CDM sequence across the DMRS REs and the orthogonalization of the ports.

At a communication device acting as a UE, the DMRS generation method is performed for the DMRS associated with one of the following channels: a PUSCH, a PUCCH or a PRACH (physical random access channel).

At a communication device acting as a network node, the DMRS generation method is performed for the DMRS associated with one of the following channels: a PDSCH, a PDCCH or a PBCH (physical broadcast channel).

Upon generation of the DMRS, as described in the above method, for a physical channel, the UE or the network node, performs the transmission of said physical channel with said DMRS.

According to some embodiments, there are M≤L different L-length sequences c_{f}(\tilde{k}). By multiplying the first sequence, r(q), with M different second sequences, c_{f}(\tilde{k}), M orthogonal real- or complex-valued sequences d(i) are obtained. This approach is used for code-division multiplexing (CDM) of DMRS ports, thereby forming CDM groups. A CDM group comprises M DMRS ports wherein the DMRS resource elements allocated in the time-frequency grid are the same for the M DMRS ports, while the symbol sequences d(i) associated with the M DMRS ports are different and orthogonal to each other. Two ports from two different CDM groups may have identical second sequences c_{f}(\tilde{k}), but a different time-frequency resource allocation. A DMRS configuration may comprise multiple CDM groups, where each CDM group is associated with a CDM group index.

According to an embodiment, the parameter L is configured via higher layer (e.g, via RRC) or physical layer (e.g., via the DCI). The parameter L indicates the CDM length and is also equal to the maximum number of DMRS ports within one CDM group that are provided with identical time-frequency allocation. Dependent on the configured value of L, CDM can be applied across the DMRS resource elements in a PRB, or across a subset or proper subset of the DMRS resource elements in a PRB, or across DMRS resource elements in multiple PRBs.

According to an embodiment, the value of L may be fixed in the NR specifications, optionally, in connection with a network indication or a network configuration.

The method described above provides the following novelty and advantages when compared to the 5G NR DMRS configuration types.

In 5G NR, the mapping of the NR DMRS CDM sequence is restricted to a single value of n within a PRB and the CDM sequence is an orthogonal cover code that is mapped to pairs of DMRS resource elements. In the method according to the described embodiments, by mapping the sequence to different values of n, novel methods of mapping the CDM sequence, such as ‘interleaved’ and ‘non-interleaved’ mapping, are enabled, which are explained in further details along with examples and configuration details below. With the variations of mapping enabled, DMRS interference mitigation between users based on similar pseudorandom binary sequences (first sequences r(q)) is a potential advantage of the proposed method. Moreover, with a flexible CDM sequence size L introduced in the method, the use of various new real and complex-valued CDM sequences other than orthogonal cover codes is made possible, as explained further below in the invention disclosure. This advantage comes with very little penalty as it preserves the peak-to-average-power ratio of the transmitted OFDM waveform and also increases the number of DMRS ports for a physical channel that can be multiplexed in a transmission without increasing the overhead of the time and frequency domain resources allocated for DMRS. There may be a marginal increase in the overhead for the indication of the DMRS ports for a certain transmission as the number of possible DMRS ports are increased due to the proposed method, which is a perfectly good trade-off for the advantages posed by the method. Thus, the proposed method is superior to the 5G NR DMRS configuration in terms of practical utility and technical novelty.

According to the values of n that the DMRS resource elements are associated with, the CDM application is either ‘interleaved’ or ‘non-interleaved’.

In an embodiment, the values of n associated with said L DMRS resource elements are consecutive resulting in a non-interleaved CDM sequence application.

In another embodiment, the values of n associated with said L DMRS resource elements are non-consecutive resulting in an interleaved CDM sequence application.

According to some embodiments, said L DMRS resource elements are associated with at least two different values of n, wherein the DMRS resource elements associated with at least one value of n are present in a first PRB and the DMRS resource elements associated with at least one other value of n are associated with a PRB that is different from the first PRB. In some examples, the DMRS resource elements associated with a first value of n are present in a first PRB and the DMRS resource elements associated with a second value of n are present in a second PRB and so on.

A consequence of the above mapping of the L-length CDM sequence and the DMRS base sequence r(q) to a subset of L DMRS resource elements is an association between the indices of the corresponding sequences n and \tilde{k}.

According to some embodiments, for a given subset of L resource elements, among the L values of \tilde{k} for the L-length sequence c_{f}(\tilde{k}), at least two of them are mapped to or associated with at least two different DMRS resource elements that are associated with at least two different values of n. The mapping/association between the variables/indices \tilde{k} and n ultimately determines the type of mapping. Functions or methods for mapping between \tilde{k} and n are provided further below for different types of mapping. Depending on the value of L and the type of interleaving associated with the mapping, the number of PRBs across the mapping of the second sequence c_{f}(\tilde{k}) is spread may differ.

According to an embodiment, L=N_{DMRS}^{RB}, wherein N_{DMRS}^{RB} is the total number of DMRS resource elements associated with a port (or CDM group) in a PRB. With non-interleaved mapping, the number of PRBs associated with the mapping of L entries of c_{f}(\tilde{k}) can be restricted to a single PRB. Here, for a DMRS configuration with an allocation similar to 3GPP DMRS configuration type 1 or 2, with a value of L=6 or 4, respectively, and non-interleaved mapping, the CDM can be applied within all DMRS resource elements within a PRB to increase the number of CDMed ports in a group. With interleaved mapping, the valid allocation to satisfy is provided further below.

According to an embodiment, L<N_{DMRS}^{RB}. In such a case, the L-length sequence c_{f}(\tilde{k}) is repeated more than once with both interleaved and non-interleaved CDM to map to the N_{DMRS}^{RB} resource elements in a PRB.

According to another embodiment, L>N_{DMRS}^{RB}. In such a case, the L-length complex-valued symbol sequence is associated with DMRS resource elements from multiple (e.g., two) PRBs. The PRBs can be adjacent or not.

Example values for L may be 4, 8 or N_{DMRS}^{RB}, where N_{DMRS}^{RB}=6 for DMRS configuration type 1 and N_{DMRS}^{RB}=4 for DMRS configuration type 2.

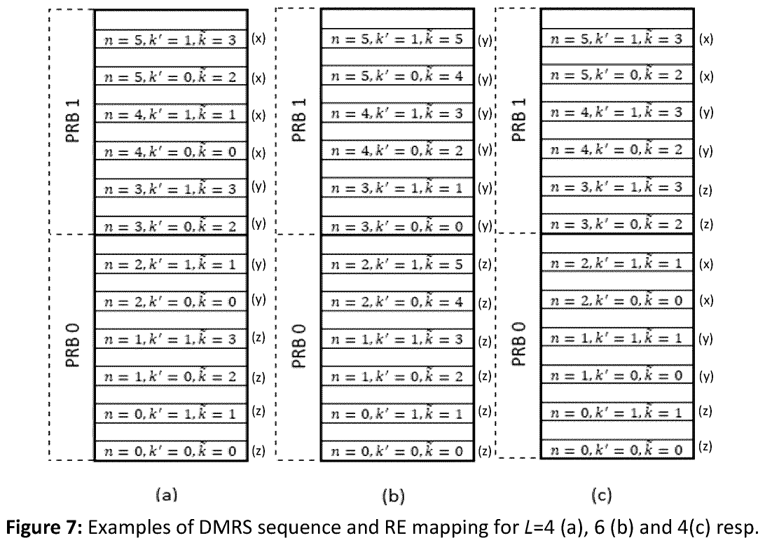

In FIG. 7 to FIG. 10, mapping schemes for different DMRS configurations and values of L, N_{DMRS}^{RB}, K′ and θ including ‘interleaved’ and ‘non-interleaved’ CDM are shown. The figures show the PRBs in one symbol of a physical channel that comprises DMRS for a specific CDM group. The indexed resource elements are DMRS resource elements. The index values n and k′ of a resource element are the ones used to calculate the index q of the first sequence r(q) used in the calculation of the complex valued symbol d(i) mapped to said RE. Similarly, the value Ã of a resource element provides the index of the entry from the second sequence c_{f}(\tilde{k}) that is used to compute the complex valued symbol d(i) mapped to said RE. A set of L DMRS REs in a given symbol with the same value of an index x, y, z or w, denotes a subset of DMRS REs in the symbol to which the L-length c_{f}(\tilde{k}) sequence corresponding to said port is applied. Multiple sets of L DMRS REs in a given symbol, with a given set having the same value of the index x, y, z or w for the DMRS REs within the set, implies that the application of L-length c_{f} (\tilde{k}) sequence corresponding to said port is repeated to each of the L-length sets.

For example, in FIG. 7(a), L=4 and the REs indicated with the same value of (x), (y) or (z) implies that the L-length c_{f}(\tilde{k}) sequence corresponding to said port is applied to each of the three L-length sets.

In FIG. 7, three possibilities of the CDM configuration and mapping are shown for a DMRS resource element mapping that is similar to DMRS configuration type 1, where N_{DMRS}^{RB}=6 and K′=2, θ=2 and φ=1. With a value of L=4, two different CDM configurations are shown in FIG. 7(a) and FIG. 7(c).

In the first allocation scheme shown for L=4 in FIG. 7(a), CDM is applied to consecutive resource elements (REs) that are associated with consecutive values of n. The resource elements (REs) may either be present in one PRB or spread across multiple PRBs. For example, REs (x) having n=5 and n=4 of PRB 1 are consecutive in FIG. 7(a). REs (y) having n=3 in PRB 1 and n=2 in PRB 0 are consecutive in FIG. 7(a); and REs (z) having n=1 and n=0 in PRB 0 are consecutive in FIG. 7(a).

In the second allocation scheme shown for L=4 in FIG. 7(c), CDM is applied to resource elements that are spread across PRBs and the values of n that they are mapped to are non-consecutive. For example, REs (x) having n=5 and REs (x) having n=2 are non-consecutive in FIG. 7(c). REs (y) having n=4 and REs (y) having n=1 are non-consecutive in FIG. 7(c); and REs (z) having n=3 and REs (z) having n=0 are non-consecutive in FIG. 7(c). This is an example of an ‘interleaved’ CDM configuration.

In FIG. 7(b), a CDM configuration is shown where L=N_{DMRS}^{RB}=6. CDM is applied to consecutive resource elements that are associated with consecutive values of n, all of which are present within one PRB. As shown in FIG. 7(b), REs (y) in PRB 0 are consecutive and REs (z) in PRB 1 are consecutive.

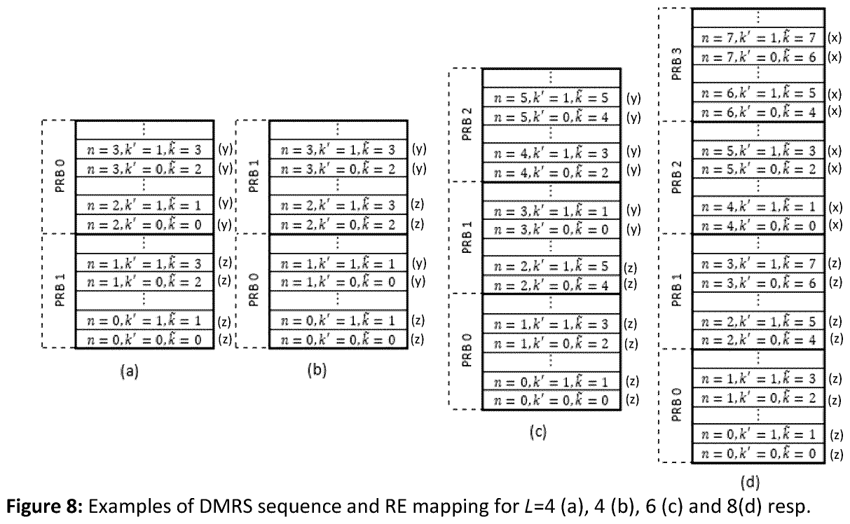

In FIG. 8, four possibilities of the CDM configuration and mapping are provided for a DMRS resource element mapping similar to configuration type 2 in which N_{DMRS}^{RB}=4 and K′=2. The DMRS configuration is θ=2 and φ=1. The CDM application is shown for L=4, 4, 6 and 8 respectively in FIG. 8(a), FIG. 8(b), FIG. 8(c) and FIG. 8(d).

In FIGS. 8(a) and (b), for the same value of L=4, both ‘interleaved’ CDM mapping and ‘non-interleaved’ mapping—mapping the CDM sequence to consecutive and non-consecutive values of n—are shown. In the first example (FIG. 8(a)), the CDM sequence is applied to DMRS REs that are always within a PRB (e.g., REs (y) in PRB 1, and REs (z) in PRB 0), while in the second example (FIG. 8(b), the CDM sequence is applied to DMRS REs associated with consecutive values of n that are spread across multiple PRBs (e.g., REs (y) in PRB 1 and in PRB 0, and REs (z) in PRB 1 and in PRB 0).

In FIG. 8(c), for a value of L=6, CDM is applied to subsets of REs that are spread over multiple PRBs (e.g., REs (y) in PRB 1 and in PRB 2, and REs (z) in PRB 0 and in PRB 1). In FIG. 8(d), for a value of L=8, the REs are spread across two PRBs (REs (x) in PRB 2 and in PRB 3 and REs (z) in PRB 0 and in PRB 1) and fit to a resource allocation with an even number of PRBs.

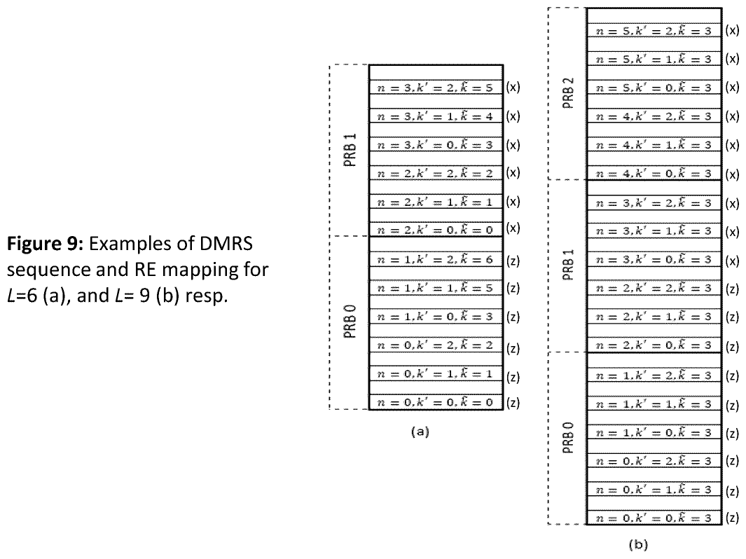

In FIG. 9, two CDM configurations and mappings are provided for a DMRS configuration with N_{DMRS}^{RB}=6 and K′=3. The DMRS configuration is θ=3 and φ=1. CDM configurations for L=6 and L=9 are shown in FIG. 9(a) and FIG. 9(b), respectively. In the first example (FIG. 9(a)), the CDM sequence is applied to the DMRS resource elements that are always within a PRB (e.g. REs (x) in PRB 1 and REs (z) in PRB 0), while in the second example (FIG. 9(b)), the CDM sequence is applied to the DMRS resource elements associated with consecutive values of n that are spread across multiple PRBs (REs (x) in PRB 1 and in PRB 2; and REs (z) in PRB 0 and in PRB 1).

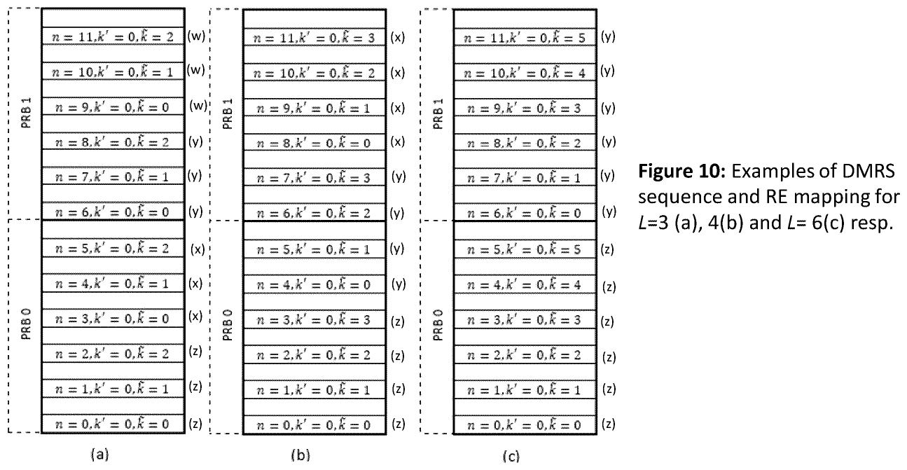

In FIG. 10, three different CDM configurations and mappings are provided for N_{DMRS}^{RB}=6 and K′=1. The DMRS configuration is θ=1. Example CDM configurations are shown for L=3, 4 and 6 in FIG. 10(a), FIG. 10(b) and FIG. 10(c), respectively. All of them are examples of non-interleaved CDM. In the first and third examples (FIG. 10(a) and FIG. 10(c)), the CDM sequence is applied to DMRS REs that are always within a PRB (REs (w) and REs (y) within PRB 1; REs (x) and REs (z) within PRB 0 in FIG. 10(a); and REs (y) within PRB 1 and REs (z) within PRB 0 in FIG. 10(c)), while in the second example (FIG. 10(b), the CDM sequence is applied to DMRS REs associated with consecutive values of n that are spread across multiple PRBs (REs (x) and REs (y) within PRB 1, and REs (y) and REs (z) within PRB 0).

In both cases of mapping, interleaved or non-interleaved, the mapping of the L length sequence c_{f}(\tilde{k}) for a port is repeated across multiple disjoint subsets of DMRS resource elements for the port to achieve orthogonality to other ports associated with the same CDM group. To achieve orthogonality, the union of the disjoint subsets of DMRS resource elements of the port, each comprising L resource elements wherein each subset is applied with the mapping of the L-length sequence c_{f}(\tilde{k}), should be equal to the set of all DMRS resource elements allocated across all PRBs. For both interleaved and non-interleaved CDM sequence application, the total number of DMRS resource elements in a symbol comprising DMRS in a given resource allocation of a physical channel, N_{DMRS}^{RB}·N_{RB}, should be an integer multiple of the CDM length L, wherein N_{RB} is the total number of PRBs of the physical channel comprising DMRS resource elements, and N_{DMRS}^{RB} is the total number of DMRS resource elements associated with a port (or CDM group) in a PRB.

In the case of interleaved CDM sequence application, a stricter condition may need to be satisfied. Consider a mapping of the CDM to the DMRS resource elements in N_{RB}≥1 PRBs, wherein c_{f}(\tilde{k}) is repeated across one or more disjoint subsets of L DMRS resource elements in said PRBs, wherein the L resource elements of a given subset are associated with at least two different values of n and are present across one or multiple PRBs. The smallest number of PRBs in which the mapping of the L-length sequence c_{f}(\tilde{k}) is repeated to U≥1 disjoint subsets of the DMRS resource elements of the PRBs, wherein each subset has L DMRS resource elements and the union of the subsets is equal to the set of all DMRS resource elements in said PRBs, can be defined as N_{c}_{_{f}}_{(\tilde{k})}^{RB}. Only for such an allocation where the CDM application can be performed in full across all the DMRS resource elements in the allocation, the orthogonality of the DMRS ports can be achieved for ports within a CDM group. Therefore, as a general rule, and according to an embodiment, the number of allocated PRBs, N_{RB}, should be an integer multiple of N_{c}_{_{f}}_{(\tilde{k})}^{RB}. In the case of interleaved mapping examples shown in FIGS. 7 (c) and 8(b), the sequence c_{f}(\tilde{k}) is mapped to U=2 and U=3 disjoint subsets of L resource elements wherein at least N_{c}_{_{f}}₍ₖ₎^{RB}=2 PRBs are required to satisfy the condition that the union of the U disjoint subsets is equal to the set of all DMRS resource elements across said PRBs.

Note that the total number of PRBs of the physical channel comprising DMRS resource elements may be the same as the total number of PRBs allocated for the physical channel itself.

As previously mentioned, example values for L may be 4, 8 or N_{DMRS}^{RB}, where N_{DMRS}^{RB}=6 for DMRS configuration type 1 and N_{DMRS}^{RB}=4 for DMRS configuration type 2.

A consequence of the condition described above would be as follows: in some examples of DMRS configuration type 1 or any DMRS configuration wherein N_{DMRS}^{RB} is equal to 6, when the value of L is 4 or 8, the number of PRBs scheduled for the DMRS and/or said physical channel is an even number. With a value of L=4, the sequence is repeated U=3 times to cover all DMRS resource elements across N_{c}_{_{f}}_{(\tilde{k})}^{RB}=2 PRBs, i.e., the least number of repetitions U of the length-4 sequence to cover all DMRS elements in an integer number of PRBs (2 PRBs here), is 3. This means that the number of PRBs scheduled for the DMRS and/or the physical channel shall be a multiple of 2, i.e., an even number. This restriction would apply to non-interleaved mapping

In the following, some relationships between the variables defined above are discussed for various DMRS mappings that could be configured.

According to an embodiment, the L DMRS resource elements comprise g≥2 segments with v≥1 resource elements per segment. Each segment is associated with a different value of n. A resource element may belong to only one segment, i.e., a resource element may be associated with only one value of n.

According to an embodiment, at least one of the following relationships among the variables defined above may apply:
K′=v,
g=L/K′.

In some examples, θ=K′. In some examples, φ=1.

As previously presented k′=0, . . . , K′−1 with K′≥1; or k′=1, . . . , K′ with K′≥2.

In accordance with an embodiment, n=0, . . . , τN_{RB}−1, where N_{RB} is the number of resource blocks allocated for the physical channel and/or the number of resource blocks allocated for the DMRS associated with said physical channel, and τ is a positive, non-zero integer. In the case of an allocation similar to NR DMRS configuration type 1, τ=3 and in the case of an allocation similar to NR DMRS configuration type 2, τ=2.

In accordance with an embodiment, at least one of the following sets are used for the DMRS sequence generation and mapping:
θ=2, φ=1, K′=2, g=2 or 3, v=2,
θ≥1, φ=1, K′=1, g=2, 3 or 4, u=1,
θ=3, φ=1, K′=3, g=2, v=3.

### Extension of NR DMRS Configuration Types 1 and 2

The above DMRS design is used in the following to extend the DMRS configurations 1 and 2. The changes are only with respect to the CDM of the DMRS, while the resource mapping of the DMRS within a PRB is not changed over the current NR design. This results in minimal specification impact in terms of scheduling changes or modification in data/control procedures.

In certain embodiments, the DMRS mapping is performed using the first sequence r(q) and the second sequence c_{f}(\tilde{k}) as

$${a}_{k , l}^{( p , μ )} = {β}_{DMRS} \cdot {w}_{t} ( {l}^{′} ) \cdot {c}_{f} ( \tilde{k} ) \cdot r ( q )$$

where q=θ·n+k′, with k, l, p and u denoting the resource element index, the symbol index (in a radio frame), the port index, and waveform numerology, respectively, and wherein

$$k = \{ \begin{matrix}4 n + 2 {k}^{′} + Δ & Configuration type {T}_{1} \\ 6 n + {k}^{′} + Δ & Configuration type {T}_{2}\end{matrix} {k}^{′} = 0 , … , {K}^{′} - 1 l = \overline{l} + {l}^{′} {l}^{′} = 0 , … , Z - 1 n = 0 , 1 , …$$

The variable \tilde{l} is associated with the symbol index and configured by the network, gNB, and/or is defined in the NR specifications. The value Δ is a subcarrier offset index within a (specific) PRB that depends on the CDM group index λ for the port p. β_{DMRS} is a positive, non-zero real number or value, and wₜ (l′) is a complex- or real-valued sequence.

The reference point for k is subcarrier 0. β_{DMRS} is a power scaling factor, and wₜ(l′) is a sequence used to apply CDM across multiple symbols (CDM across the time domain).

Configuration type T₁ and type T₂ introduced above are extensions of the current NR DMRS configuration type 1 and type 2, respectively. They have a similar resource element mapping as the corresponding NR DMRS configurations.

According to an embodiment, the value \tilde{k} used in c_{f}(\tilde{k}) for the above mapping is computed using at least one of the following indices/parameters: k, k′, N_{sc}^{RB}, N_{DMRS}^{RB}, n, Δ, L. Hence, \tilde{k} is calculated/determined only by the indices/parameters associated with the frequency domain and/or the CDM length L. The CDM application in the time and frequency domain are thus separated.

In some embodiments, at least one of the following may apply for the above mapping:
θ=K′
K′=2
Z=1 or Z=2

With the aforementioned values, a segment of DMRS resource elements comprises two REs that are mapped to the time and frequency domain grid using the variables k′ and Δ.

For the above mapping method, M+Z ports per CDM group are obtained. For Z=1 (single symbol DMRS configuration), there are M orthogonal ports multiplexed in the frequency domain. For Z=2 (double symbol DMRS configuration), there are 2M orthogonal ports multiplexed in time and frequency domain, wherein orthogonalization of the DMRS sequences in time is obtained via wₜ (l′).

Design of the Second Sequence c_{f}(\tilde{k})

Maintaining unit magnitude entries with only phase changes prevents changes in the peak-to-average-power-ratio (PAPR) of the waveform. Moreover, constant or uniform phase changes are also helpful in simplifying the DMRS implementation and mapping. Therefore, in certain embodiments, the absolute phase difference between two entries at positions t−1 and t of the sequence, c_{f}(\tilde{k}), for a given port p is identical to the phase difference of entries at positions t′ and t′+1 of the sequence, where t≠t′.

In certain embodiments, the sequence c_{f}(\tilde{k}) comprises complex-valued entries with equal magnitude. In some examples, the entries are defined by complex exponentials e^{-ω\sqrt{-1}}, wherein ω=±απ for some α is a rational number. In another example, the entries are defined by complex exponentials e^{-ω\sqrt{-1}}, wherein ω is a real number.

According to an embodiment, the second sequence c_{f}(\tilde{k}), \tilde{k}=0, 1, . . . , L, is given for port p by a column or a row of a, Discrete Fourier Transform, DFT, based matrix (e.g., a DFT matrix or Inverse DFT, IDFT, matrix) of size L×L, or a Discrete Cosine Transform, DCT, based matrix of size L×L, or any other orthogonal or unitary matrix of size L×L. In some examples, the L-length orthogonalizing sequences c_{f}(\tilde{k}) for M≤L ports of a given CDM group are a subset of the columns of a DFT-based or a DCT-based matrix.

In accordance with an embodiment, the second sequence c_{f}(\tilde{k}), K=0, 1, . . . , L, for a port p is given by a column or a row of a Hadamard matrix of size L×L. This can be used when the value of L is a power of 2.

Based on the above, DMRS design can be used to extend the current NR DMRS configuration type 1 with up to 6 or 12 ports per CDM group and the current NR DMRS configuration type 2 with up to 4 or 8 ports per CDM group.

In certain embodiments, in the proposed DMRS single symbol configuration, there are two CDM groups, each comprising eight ports, wherein the first four ports comprise the first CDM group, and the second four ports comprise the second CDM group. In some examples, the value of L=4 and the DMRS ports of the first or second CDM group occupy eight subcarriers over two PRBs. In some examples, the ports are numbered 1000, . . . , 1007.

In the following, different mappings of the variable \tilde{k} to subcarrier positions in the frequency domain are provided.

In certain embodiments, the value of \tilde{k} to be used for a resource element is computed in one of the following ways or equations:

$$\tilde{k} = \frac{mod ( k - Δ , {N}_{sc}^{R B} )}{2} , \tilde{k} = mod ( 2 n + {k}^{′} , {N}_{DMRS}^{R B} ) , \tilde{k} = mod ( mod ( k - Δ , {N}_{sc}^{R B} ) , {N}_{DMRS}^{R B} ) , \tilde{k} = mod ( 2 n + {k}^{′} , L ) .$$

The value of N_{DMRS}^{RB} is equal to 6 and 4 for the NR DMRS configuration type 1 and type 2, respectively. In the following it is assumed that N_{DMRS}^{RB} is equal to 6 and 4 as well for the proposed DMRS configuration type T₁ and type T₂, respectively.

The above first and second equations for \tilde{k} may be applicable for DMRS configuration T₁. The second and third equations may be applicable for DMRS configuration T₂. The first three equations are applicable when the length of the sequence c_{f}(\tilde{k}) is equal to the number of DMRS resource elements in a PRB. When a different value of L for the sequence c_{f}(\acute{k}) is chosen, the fourth equation may be used to compute Ã instead.

The following rule may apply when L=N_{DMRS}^{RB}.

In certain embodiments, if the subcarrier positions of the N_{DMRS}^{RB} DMRS resource elements for a DMRS port p within a PRB of a symbol in the radio frame in a transmission are e₀, . . . , e_{N}_{_{DMRS}}_{^{RB}}₋₁, after an ordering of the subcarrier positions in ascending or descending order, then the value of \tilde{k} used for the resource element at position eⱼ, j=0, 1, . . . , N_{DMRS}^{RB}−1 is computed in one of the following ways:
j,
j+1,
mod (j, N_{DMRS}^{RB}).

The above methods to calculate \tilde{k} can be used in the case of non-interleaved CDM mapping. A different expression for interleaved CDM mapping, with definition of extra parameters may be required. According to an embodiment, the value of k to be used for a resource element is computed as follows:

$$\tilde{k} = {k}^{′} + mod ( mod ( ⌊ \frac{2 n + {k}^{′}}{{K}^{′} \cdot {N}_{sep}} ⌋ , {N}_{{c}_{f} ( \tilde{k} )}^{( n )} ) \cdot {K}^{′} , L ) ,$$

wherein
Nₛₑₚ is the difference between the two closest values of n that the sequence is mapped to, and
N_{c}_{_{f}}_{(\tilde{k})}⁽ⁿ⁾ is the smallest number of consecutive values of n across which the sequence c_{f}(\tilde{k}) is mapped, wherein the mapping is performed to U≥1 disjoint subsets of the associated DMRS resource elements with L DMRS resource elements in each subset and the union of the subsets is equal to the set of all DMRS resource elements associated with said values of n.

This may be applicable when the second sequence c_{f}(\tilde{k}) is mapped to a subset of L DMRS resource elements that are associated with non-consecutive values of n. The values Nₛₑₚ and N_{c}_{_{f}}_{(\tilde{k})}ⁿ can be considered as the parameters of the interleaved CDM. For example, in the interleaved mappings illustrated in the figures, Nₛₑₚ=3 and N_{c}_{_{f}}_{(\tilde{k})}ⁿ=6 in FIG. 7(c) and Nₛₑₚ=2 and N_{c}_{_{f}}_{(\tilde{k})}ⁿ=4 in FIG. 8(b). The parameters Nₛₑₚ and/or N_{c}_{_{f}}_{(\tilde{k})}ⁿ can either be higher layer configured/indicated and/or fixed in the specifications. With the mapping methods described above, the following DMRS configurations are possible.

In certain embodiments, at least one of the following apply for DMRS configuration T₁ or T₂:
The value Δ used in the formula above is identical for at least 8 ports
The value of the CDM group index λ is identical for at least 8 ports
The DMRS configuration provides up to 2 CDM groups

In accordance with an embodiment, the difference in the complex phase between any two adjacent entries of c_{f}(\tilde{k}) for a given port p is π/3 or −π/3 or an integer multiple of π/3 or −π/3.

In an example, the difference in the complex phase between any two adjacent entries of c_{f}(\tilde{k}) for a given port p is one of the following (in radians): 0, π, 2π/3, π/3, −π, −2π/3, −π/3. This can be used to extend the NR DMRS configuration type 1 to up to 8 ports per CDM group.

In certain embodiments, at least one of the following applies for DMRS configuration T₁ or T₂:
The value Δ used in the formula above is identical for at least 6 DMRS ports
The value of the CDM group index λ is identical for at least 6 DMRS ports
The DMRS configuration provides 2 or 3 CDM groups

In accordance with some embodiments, the difference of the complex phase between two adjacent entries of c_{f}(\tilde{k}) is π/2 or −π/2, or an integer multiple of π/2 or −π/2. In one example, the difference in the complex phase between any two adjacent entries of c_{f}(\tilde{k}) for a given port p is one of the following (in radians): 0, π, π/2, −π, −π/2. This can be used to extend the NR DMRS configuration type 2 to up to 8 ports per CDM group.

In accordance with some embodiments, at least one of the following applies for the DMRS configuration:
The value Δ used in the formula above is identical for at least 12 ports
The value of the CDM group index λ is identical for at least 12 ports
The DMRS configuration provides up to 2 CDM groups

From the aforementioned sequences c_{f}(\tilde{k}), DMRS tables for the CDM groups/ports are provided below.

The value of k for the DMRS mapping can be computed according to one of the equations provided above and the corresponding entry for c_{f}(\tilde{k}) is provided in the tables below. Examples for the DMRS configurations are provided in the following Tables 1 to Table 6.

TABLE 1
DMRS configuration (6 REs per PRB) for 16 ports with 8 ports
per CDM group (4 ports per CDM group for single symbol DMRS).

| | CDM | | | | | | | | | |
|---|---|---|---|---|---|---|---|---|---|---|
| | group | | c_{f}(\tilde{k}) | | | | | | wₜ(l′) | |
| p | λ | Δ | \tilde{k} = 0 | \tilde{k} = 1 | \tilde{k} = 2 | \tilde{k} = 3 | \tilde{k} = 4 | \tilde{k} = 5 | l′ = 0 | l′ = 1 |
| p₀ | 0 | 0 | +1 | +1 | +1 | +1 | +1 | +1 | +1 | +1 |
| p₁ | 0 | 0 | +1 | −1 | +1 | −1 | +1 | −1 | +1 | +1 |
| p₂ | 0 | 0 | +1 | e^{-j2π/3} | e^{-j4π/3} | +1 | e^{-j2π/3} | e^{-j4π/3} | +1 | +1 |
| p₃ | 0 | 0 | +1 | e^{-jπ/3} | e^{-j2π/3} | −1 | e^{-j4π/3} | e^{-j5π/3} | +1 | +1 |
| p₄ | 1 | 1 | +1 | +1 | +1 | +1 | +1 | +1 | +1 | +1 |
| p₅ | 1 | 1 | +1 | −1 | +1 | −1 | +1 | −1 | +1 | +1 |
| p₆ | 1 | 1 | +1 | e^{-j2π/3} | e^{-j4π/3} | +1 | e^{-j2π/3} | e^{-j4π/3} | +1 | +1 |
| p₇ | 1 | 1 | +1 | e^{-jπ/3} | e^{-j2π/3} | −1 | e^{-j4π/3} | e^{-j5π/3} | +1 | +1 |
| p₈ | 0 | 0 | +1 | +1 | +1 | +1 | +1 | +1 | +1 | −1 |
| p₉ | 0 | 0 | +1 | −1 | +1 | −1 | +1 | −1 | +1 | −1 |
| p₁₀ | 0 | 0 | +1 | e^{-j2π/3} | e^{-j4π/3} | +1 | e^{-j2π/3} | e^{-j4π/3} | +1 | −1 |
| p₁₁ | 0 | 0 | +1 | e^{-jπ/3} | e^{-j2π/3} | −1 | e^{-j4π/3} | e^{-j5π/3} | +1 | −1 |
| p₁₂ | 1 | 1 | +1 | +1 | +1 | +1 | +1 | +1 | +1 | −1 |
| p₁₃ | 1 | 1 | +1 | −1 | +1 | −1 | +1 | −1 | +1 | −1 |
| p₁₄ | 1 | 1 | +1 | e^{-j2π/3} | e^{-j4π/3} | +1 | e^{-j2π/3} | e^{-j4π/3} | +1 | −1 |
| p₁₅ | 1 | 1 | +1 | e^{-jπ/3} | e^{-j2π/3} | −1 | e^{-j4π/3} | e^{-j5π/3} | +1 | −1 |

TABLE 2
DMRS configuration (6 REs per PRB) for 24 ports with 12 ports
per CDM group (6 ports per CDM group for single symbol DMRS).

| | CDM | | | | | | | | | |
|---|---|---|---|---|---|---|---|---|---|---|
| | group | | c_{f}(\tilde{k}) | | | | | | wₜ(l′) | |
| p | λ | Δ | \tilde{k} = 0 | \tilde{k} = 1 | \tilde{k} = 2 | \tilde{k} = 3 | \tilde{k} = 4 | \tilde{k} = 5 | l′ = 0 | l′ = 1 |
| p₀ | 0 | 0 | +1 | +1 | +1 | +1 | +1 | +1 | +1 | +1 |
| p₁ | 0 | 0 | +1 | e^{-jπ/3} | e^{-j2π/3} | −1 | e^{j2π/3} | e^{jπ/3} | +1 | +1 |
| p₂ | 0 | 0 | +1 | e^{-j2π/3} | e^{-j4π/3} | +1 | e^{j4π/3} | e^{j2π/3} | +1 | +1 |
| p₃ | 0 | 0 | +1 | −1 | +1 | −1 | +1 | −1 | +1 | +1 |
| p₄ | 0 | 0 | +1 | e^{-j4π/3} | e^{-j8π/3} | +1 | e^{j8π/3} | e^{j4π/3} | +1 | +1 |
| p₅ | 0 | 0 | +1 | e^{-j5π/3} | e^{-j10π/3} | −1 | e^{j10π/3} | e^{j5π/3} | +1 | +1 |
| p₆ | 1 | 1 | +1 | +1 | +1 | +1 | +1 | +1 | +1 | +1 |
| p₇ | 1 | 1 | +1 | e^{-jπ/3} | e^{-j2π/3} | −1 | e^{j2π/3} | e^{jπ/3} | +1 | +1 |
| p₈ | 1 | 1 | +1 | e^{-j2π/3} | e^{-j4π/3} | +1 | e^{j4π/3} | e^{j2π/3} | +1 | +1 |
| p₉ | 1 | 1 | +1 | −1 | +1 | −1 | +1 | −1 | +1 | +1 |
| p₁₀ | 1 | 1 | +1 | e^{-j4π/3} | e^{-j8π/3} | +1 | e^{j8π/3} | e^{j4π/3} | +1 | +1 |
| p₁₁ | 1 | 1 | +1 | e^{-j5π/3} | e^{-j10π/3} | −1 | e^{j10π/3} | e^{j5π/3} | +1 | +1 |
| p₁₂ | 0 | 0 | +1 | +1 | +1 | +1 | +1 | +1 | +1 | −1 |
| p₁₃ | 0 | 0 | +1 | e^{-jπ/3} | e^{-j2π/3} | −1 | e^{j2π/3} | e^{jπ/3} | +1 | −1 |
| p₁₄ | 0 | 0 | +1 | e^{-j2π/3} | e^{-j4π/3} | +1 | e^{j4π/3} | e^{j2π/3} | +1 | −1 |
| p₁₅ | 0 | 0 | +1 | −1 | +1 | −1 | +1 | −1 | +1 | −1 |
| p₁₆ | 0 | 0 | +1 | e^{-j4π/3} | e^{-j8π/3} | +1 | e^{j8π/3} | e^{j4π/3} | +1 | −1 |
| p₁₇ | 0 | 0 | +1 | e^{-j5π/3} | e^{-j10π/3} | −1 | e^{j10π/3} | e^{j5π/3} | +1 | −1 |
| p₁₈ | 1 | 1 | +1 | +1 | +1 | +1 | +1 | +1 | +1 | −1 |
| p₁₉ | 1 | 1 | +1 | e^{-jπ/3} | e^{-j2π/3} | −1 | e^{j2π/3} | e^{jπ/3} | +1 | −1 |
| p₂₀ | 1 | 1 | +1 | e^{-j2π/3} | e^{-j4π/3} | +1 | e^{j4π/3} | e^{j2π/3} | +1 | −1 |
| p₂₁ | 1 | 1 | +1 | −1 | +1 | −1 | +1 | −1 | +1 | −1 |
| p₂₂ | 1 | 1 | +1 | e^{-j4π/3} | e^{-j8π/3} | +1 | e^{j8π/3} | e^{j4π/3} | +1 | −1 |
| p₂₃ | 1 | 1 | +1 | e^{-j5π/3} | e^{-j10π/3} | −1 | e^{j10π/3} | e^{j5π/3} | +1 | −1 |

TABLE 3
DMRS configuration (4 REs per PRB) for 18 ports with 6 ports
per CDM group (3 ports per CDM group for single symbol DMRS).

| | CDM | | | | | | | |
|---|---|---|---|---|---|---|---|---|
| | group | | c_{f}(\tilde{k}) | | | | wₜ(l′) | |
| p | λ | Δ | \tilde{k} = 0 | \tilde{k} = 1 | \tilde{k} = 2 | \tilde{k} = 3 | l′ = 0 | l′ = 1 |
| p₀ | 0 | 0 | +1 | +1 | +1 | +1 | +1 | +1 |
| p₁ | 0 | 0 | +1 | −1 | +1 | −1 | +1 | +1 |
| p₂ | 0 | 0 | +1 | −j | −1 | j | +1 | +1 |
| p₃ | 1 | 2 | +1 | +1 | +1 | +1 | +1 | +1 |
| p₄ | 1 | 2 | +1 | −1 | +1 | −1 | +1 | +1 |
| p₅ | 1 | 2 | +1 | −j | −1 | j | +1 | +1 |
| p₆ | 2 | 4 | +1 | +1 | +1 | +1 | +1 | +1 |
| p₇ | 2 | 4 | +1 | −1 | +1 | −1 | +1 | +1 |
| p₈ | 2 | 4 | +1 | −j | −1 | j | +1 | +1 |
| p₉ | 0 | 0 | +1 | +1 | +1 | +1 | +1 | −1 |
| p₁₀ | 0 | 0 | +1 | −1 | +1 | −1 | +1 | −1 |
| p₁₁ | 0 | 0 | +1 | −j | −1 | j | +1 | −1 |
| p₁₂ | 1 | 2 | +1 | +1 | +1 | +1 | +1 | −1 |
| p₁₃ | 1 | 2 | +1 | −1 | +1 | −1 | +1 | −1 |
| p₁₄ | 1 | 2 | +1 | −j | −1 | j | +1 | −1 |
| p₁₅ | 2 | 4 | +1 | +1 | +1 | +1 | +1 | −1 |
| p₁₆ | 2 | 4 | +1 | −1 | +1 | −1 | +1 | −1 |
| p₁₇ | 2 | 4 | +1 | −j | −1 | j | +1 | −1 |

TABLE 4
DMRS configuration (4 REs per PRB) for 24 ports with 8 ports
per CDM group (4 ports per CDM group for single symbol DMRS).

| | CDM | | | | | | | |
|---|---|---|---|---|---|---|---|---|
| | group | | c_{f}(\tilde{k}) | | | | wₜ(l′) | |
| p | λ | Δ | \tilde{k} = 0 | \tilde{k} = 1 | \tilde{k} = 2 | \tilde{k} = 3 | l′ = 0 | l′ = 1 |
| p₀ | 0 | 0 | +1 | +1 | +1 | +1 | +1 | +1 |
| p₁ | 0 | 0 | +1 | −1 | +1 | −1 | +1 | +1 |
| p₂ | 0 | 0 | +1 | +1 | −1 | −1 | +1 | +1 |
| p₃ | 0 | 0 | +1 | −1 | −1 | +1 | +1 | +1 |
| p₄ | 1 | 2 | +1 | +1 | +1 | +1 | +1 | +1 |
| p₅ | 1 | 2 | +1 | −1 | +1 | −1 | +1 | +1 |
| p₆ | 1 | 2 | +1 | +1 | −1 | −1 | +1 | +1 |
| p₇ | 1 | 2 | +1 | −1 | −1 | +1 | +1 | +1 |
| p₈ | 2 | 4 | +1 | +1 | +1 | +1 | +1 | +1 |
| p₉ | 2 | 4 | +1 | −1 | +1 | −1 | +1 | +1 |
| p₁₀ | 2 | 4 | +1 | +1 | −1 | −1 | +1 | +1 |
| p₁₁ | 2 | 4 | +1 | −1 | −1 | +1 | +1 | +1 |
| p₁₂ | 0 | 0 | +1 | +1 | +1 | +1 | +1 | −1 |
| p₁₃ | 0 | 0 | +1 | −1 | +1 | −1 | +1 | −1 |
| p₁₄ | 0 | 0 | +1 | +1 | −1 | −1 | +1 | −1 |
| p₁₅ | 0 | 0 | +1 | −1 | −1 | +1 | +1 | −1 |
| p₁₆ | 1 | 2 | +1 | +1 | +1 | +1 | +1 | −1 |
| p₁₇ | 1 | 2 | +1 | −1 | +1 | −1 | +1 | −1 |
| p₁₈ | 1 | 2 | +1 | +1 | −1 | −1 | +1 | −1 |
| p₁₉ | 1 | 2 | +1 | −1 | −1 | +1 | +1 | −1 |
| p₂₀ | 2 | 4 | +1 | +1 | +1 | +1 | +1 | −1 |
| p₂₁ | 2 | 4 | +1 | −1 | +1 | −1 | +1 | −1 |
| p₂₂ | 2 | 4 | +1 | +1 | −1 | −1 | +1 | −1 |
| p₂₃ | 2 | 4 | +1 | −1 | −1 | +1 | +1 | −1 |

TABLE 5
DMRS configuration (4 REs per PRB) for 24 ports with 8 ports
per CDM group (4 ports per CDM group for single symbol DMRS).

| | CDM | | | | | | | |
|---|---|---|---|---|---|---|---|---|
| | group | | c_{f}(\tilde{k}) | | | | wₜ(l′) | |
| p | λ | Δ | \tilde{k} = 0 | \tilde{k} = 1 | \tilde{k} = 2 | \tilde{k} = 3 | l′ = 0 | l′ = 1 |
| p₀ | 0 | 0 | +1 | +1 | +1 | +1 | +1 | +1 |
| p₁ | 0 | 0 | +1 | e^{-jπ/2} | e^{-jπ} | e^{-j3π/2} | +1 | +1 |
| p₂ | 0 | 0 | +1 | e^{jπ} | +1 | e^{-jπ} | +1 | +1 |
| p₃ | 0 | 0 | +1 | e^{jπ/2} | e^{jπ} | e^{j3π/2} | +1 | +1 |
| p₄ | 1 | 2 | +1 | +1 | +1 | +1 | +1 | +1 |
| p₅ | 1 | 2 | +1 | e^{-jπ/2} | e^{-jπ} | e^{-j3π/2} | +1 | +1 |
| p₆ | 1 | 2 | +1 | e^{jπ} | +1 | e^{-jπ} | +1 | +1 |
| p₇ | 1 | 2 | +1 | e^{jπ/2} | e^{jπ} | e^{jπ/2} | +1 | +1 |
| p₈ | 2 | 4 | +1 | +1 | +1 | +1 | +1 | +1 |
| p₉ | 2 | 4 | +1 | e^{-jπ/2} | e^{-jπ} | e^{-j3π/2} | +1 | +1 |
| p₁₀ | 2 | 4 | +1 | e^{jπ} | +1 | e^{-jπ} | +1 | +1 |
| p₁₁ | 2 | 4 | +1 | e^{jπ/2} | e^{jπ} | e^{j3π/2} | +1 | +1 |
| p₁₂ | 0 | 0 | +1 | +1 | +1 | +1 | +1 | −1 |
| p₁₃ | 0 | 0 | +1 | e^{-jπ/2} | e^{-jπ} | e^{-j3π/2} | +1 | −1 |
| p₁₄ | 0 | 0 | +1 | e^{jπ} | +1 | e^{-jπ} | +1 | −1 |
| p₁₅ | 0 | 0 | +1 | e^{jπ/2} | e^{jπ} | e^{j3π/2} | +1 | −1 |
| p₁₆ | 1 | 2 | +1 | +1 | +1 | +1 | +1 | −1 |
| p₁₇ | 1 | 2 | +1 | e^{-jπ/2} | e^{-jπ} | e^{-j3π/2} | +1 | −1 |
| p₁₈ | 1 | 2 | +1 | e^{jπ} | +1 | e^{-jπ} | +1 | −1 |
| p₁₉ | 1 | 2 | +1 | e^{jπ/2} | e^{jπ} | e^{j3π/2} | +1 | −1 |
| p₂₀ | 2 | 4 | +1 | +1 | +1 | +1 | +1 | −1 |
| p₂₁ | 2 | 4 | +1 | e^{-jπ/2} | e^{-jπ} | e^{-j3π/2} | +1 | −1 |
| p₂₂ | 2 | 4 | +1 | e^{jπ} | +1 | e^{-jπ} | +1 | −1 |
| p₂₃ | 2 | 4 | +1 | e^{jπ/2} | e^{jπ} | e^{j3π/2} | +1 | −1 |

TABLE 6
DMRS configuration (6 REs per PRB) for 16 ports with 8 ports
per CDM group (4 ports per CDM group for single symbol DMRS).

| | CDM | | | | | | | |
|---|---|---|---|---|---|---|---|---|
| | group | | c_{f}(\tilde{k}) | | | | wₜ(l′) | |
| p | λ | Δ | \tilde{k} = 0 | \tilde{k} = 1 | \tilde{k} = 2 | \tilde{k} = 3 | l′ = 0 | l′ = 1 |
| p₀ | 0 | 0 | +1 | +1 | +1 | +1 | +1 | +1 |
| p₁ | 0 | 0 | +1 | −1 | +1 | −1 | +1 | +1 |
| p₂ | 0 | 0 | +1 | +1 | −1 | −1 | +1 | +1 |
| p₃ | 0 | 0 | +1 | −1 | −1 | +1 | +1 | +1 |
| p₄ | 1 | 1 | +1 | +1 | +1 | +1 | +1 | +1 |
| p₅ | 1 | 1 | +1 | −1 | +1 | −1 | +1 | +1 |
| p₆ | 1 | 1 | +1 | +1 | −1 | −1 | +1 | +1 |
| p₇ | 1 | 1 | +1 | −1 | −1 | +1 | +1 | +1 |
| p₈ | 0 | 0 | +1 | +1 | +1 | +1 | +1 | −1 |
| p₉ | 0 | 0 | +1 | −1 | +1 | −1 | +1 | −1 |
| p₁₀ | 0 | 0 | +1 | +1 | −1 | −1 | +1 | −1 |
| p₁₁ | 0 | 0 | +1 | −1 | −1 | +1 | +1 | −1 |
| p₁₂ | 1 | 1 | +1 | +1 | +1 | +1 | +1 | −1 |
| p₁₃ | 1 | 1 | +1 | −1 | +1 | −1 | +1 | −1 |
| p₁₄ | 1 | 1 | +1 | +1 | −1 | −1 | +1 | −1 |
| p₁₅ | 1 | 1 | +1 | −1 | −1 | +1 | +1 | −1 |

The configuration provided in Table 6 above differs from the other configurations provided in Table 1 to Table 5. Here, for the DMRS mapping similar to DMRS configuration type 1, wherein 6 DMRS REs are present per resource block, only 4 REs are CDMed across the frequency domain. This is similar to FIG. 7(a). The remaining two REs of the PRB are combined with two REs from the adjacent PRB. Such a DMRS configuration is applicable when the number of PRBs is even.

In any of the tables given above, the values p; for a port may take suitable values according to the channel that the tables are used for or may take suitable values based on any other criteria.

In addition to the DMRS configurations described above, further configurations with different values of the associated variables and CDM sequence mapping are possible.

### Miscellaneous Specification Impact

For transmissions from multiple Transmission and Reception Points (TRPs) to the UE, multiple Transmission Configuration Indicator-states (TCI-states) are associated with a PDSCH. The PDSCH is transmitted from two different TRPs and the DMRS configuration may comprise multiple CDM groups for the associated DMRS used for channel estimation at the UE. A TRP may be viewed as a network node or a gNB.

In certain embodiment, the UE is configured to receive a DCI indicating two TCI-states for a PDSCH wherein the DMRS configuration associated with the PDSCH has at least two different CDM groups.

A use for a CDM configuration for DMRS that does not modify the resource element mapping of the DMRS configuration is the dynamic modification of the application of the CDM type.

In accordance with an embodiment, the UE is configured to receive a signaling from a network node via the PHY-layer or a higher layer that indicates whether the L-length second sequence used in the computation of complex valued symbols to map to a subset of L DMRS resource elements for a port p of the DMRS of a physical channel is a sequence (for e.g., w_{f} (k′) as in 5G NR) that maps only to a single value of n or a sequence (for e.g., c_{f}(\tilde{k}) as described above) that maps to at least two different values of n. For example, a PDCCH may carry an indication of the sequence (and hence the CDM method) used for the DMRS for one or more physical channels scheduled by it or for any other channel(s). It may also indicate the same for one or more transmission occasions of any given channel using a dedicated field or by reusing the codepoints (values) of an existing field. This would enable a dynamic indication of the DMRS CDM configuration. In a second example, a Medium Access Control-Control Element (MAC-CE) message may carry an indication of the DMRS sequence to be used for a specific channel or a group of two or more channels or a subset of transmission occasions of one or more channel(s). This enables semi-persistent indication of the DMRS CDM configuration. RRC indication of the DMRS CDM configuration would provide a semi-static indication of the same.

It can be observed that the new CDM methods increase the number of ports per CDM group, thereby increasing the total number of ports for a given DMRS configuration type. This means that the field in the PDCCH that indicates the DMRS ports for a DL or UL transmission (PDSCH or PUSCH) has to be enhanced to indicate the ports with the new IDs that have been added. Therefore, to reduce the specification impact, while the number of DMRS ports per CDM group are increased, the total number of ports may be kept constant so that no PDCCH enhancement would be required. This would obviously entail the reduction in the number of CDM groups possible with a given DMRS configuration type. For example, with the uniform phase increase method for CDM as in table 1, DMRS configuration type would have double the number of ports than is currently has for the same number of CDM groups. However, if only CDM group 0 is retained in the new CDM method for the specifications, then the total number of ports with the new CDM methods and the current CDM method would be 8. While this prevents further possibilities of the DMRS configuration type, the PDCCH enhancement may be avoided, thereby saving specification effort.

As demonstrated, the embodiments of this invention disclosure propose enhancements for the NR demodulation reference signal, DMRS, and the corresponding DMRS configuration. However, the method proposed above can also be used with any other kind of reference signal, e.g., CSI-RS (Channel State Information Reference Signal), SRS (Sounding Reference Signal), etc.

DMRS/Antenna Ports Indication for DMRS Configurations with Enhanced Port Density

With an enhanced DMRS port density, the total number of available DMRS ports for a DMRS configuration increases. To perform indication of the increased number of DMRS ports in various control information formats such as the downlink control information and the sidelink control information, the indication of the DMRS ports in them should also be enhanced. In the following, solutions for DMRS port(s) indication are proposed that enable backward compatibility with existing DMRS configurations, minimize specification impact and reduce specification and implementation effort.

### Port-Mapping

Mapping of existing DMRS port indices to an expanded list of DMRS port indices obtained due to port densification helps in using a broader array of ports for transmission or reception of physical channels. The different mapping techniques that may be used for this purpose are discussed below.

In accordance with some embodiments, the communication device (e.g., the UE) is configured to
receive an indication of n≥1 DMRS port indices {p₀, . . . , pₙ₋₁} via one or more fields in a DCI/SCI that schedules a physical uplink, downlink or sidelink channel, and
determine 1≤m≤n DMRS port indices {q₀, . . . , qₘ₋₁}, wherein each DMRS port index qᵢ, i∈{0, . . . , m−1} is determined using the one or more of the DMRS port indices {p₀, . . . , pₙ₋₁}, and
using the obtained DMRS port indices {q₀, . . . , qₘ₋₁} for the transmission or reception of said physical channel.

The correspondence between the indicated ports {p₀, . . . , pₙ₋₁} and the obtained port indices {q₀, . . . , qₘ₋₁} may be one-to-one or many-to-one. This means that a port index qᵢ is determined using a single port index pⱼ or multiple port indices {pⱼ_{₀}, . . . , pⱼ_{_{α}}}. One or more ports from {p₀, . . . , pₙ₋₁} is/are mapped to a port qᵢ using an identity, linear or a non-linear function/mapping. In some examples, qᵢ≠q_{i′} if i≠i′, i.e., each of the obtained port index qᵢ is unique.

In certain embodiments, for the identity mapping, a DMRS port index pⱼ, j∈{0, . . . , n−1} provided by an antenna ports indication field in the DCI/SCI is directly mapped to a DMRS port index qᵢ, i∈{0, . . . , m−1}, i.e., qᵢ=pⱼ, i∈{0, . . . , m−1} and j∈{0, . . . , n−1}. Note that for the identity mapping, the correspondence between qᵢ and the indicated port pⱼ is one-to-one.

An identity mapping is the same as choosing one of the indicated port indices and using as is in the transmission or reception of the physical channel. With this understanding, the above method can also be expressed as follows:

In accordance with embodiments, the communication device (e.g., the UE) is configured to
receive an indication of n≥1 DMRS port indices {p₀, . . . , pₙ₋₁} via one or more fields in a DCI/SCI that schedules a physical uplink, downlink or sidelink channel, and
determine 1≤m≤n DMRS port indices {q₀, . . . , qₘ₋₁}, wherein each DMRS port index qᵢ, i∈{0, . . . , m−1} is either chosen from {p₀, . . . , pₙ₋₁}, i.e., qᵢ=pⱼ, j∈{0, . . . , n−1}, or determined via the application of a mapping function to one or more of the DMRS port indices {p₀, . . . , pₙ₋₁}, and
using the obtained DMRS port indices {q₀, . . . , qₘ₋₁} for the transmission or reception of said physical channel.

As previously described, the DCI is typically transmitted from a network node to a UE and the SCI is transmitted from a network node or a UE to another UE.

Hence, according to an embodiments, when the communication device acts as a network node (or gNB), the network node is configured to:
transmit, to a communication device acting as a UE, an indication of n≥1 DMRS port indices {p₀, . . . , pₙ₋₁} via one or more fields in a DCI/SCI that schedules a physical uplink, downlink or sidelink channel, for enabling the UE to:
determine 1≤m≤n DMRS port indices {q₀, . . . , qₘ₋₁}, wherein each DMRS port index qᵢ, i∈{0, . . . , m−1} is either chosen from {p₀, . . . , pₙ₋₁}, i.e., qᵢ=pⱼ, j∈{0, . . . , n−1}, or determined via the application of a mapping function to one or more of the DMRS port indices {p₀, . . . , pₙ₋₁}, and
   using the obtained DMRS port indices {q₀, . . . , qₘ₋₁} for the transmission or reception of said physical channel.

In certain embodiments, a linear or non-linear mapping of one or more ports indicated via a DCI/SCI may be used to determine a port index used for the transmission of a physical channel. This means that one or more DMRS port indices {pⱼ_{₀}, . . . , pⱼ_{_{α-1}}_{} (α≥}1 with jₛ∈{0, . . . , n−1} for s=0, . . . α−1 and jₛ≠j_{s′} if s≠s′) indicated by one or more antenna/DMRS ports indication fields in a DCI/SCI is/are mapped to a port index qᵢ via a linear or non-linear function h(·), i.e., qᵢ=h (pⱼ_{₀}, . . . , pⱼ_{_{α−1}}).

Some examples of the function h(·) when α=1 are provided in the following. A DMRS port index q is obtained from one of the indicated DMRS port indices pⱼ via the application of a linear or a non-linear function.
h(x)=a·x+b, where a>0, b≥0.
h(x)=a·└g(x)·θ/γ┘+b or h(x)=a·┌x·θ/γ┐+b where g is a linear or non-linear function with a, γ>0 and θ, b≥0.
h(x)=d·(g(x)mod a)+b, where g is a linear or non-linear function with a, d>0 and b≥0.

Some examples of the function h(·) when α>1 are provided in the following. In this case, α>1 DMRS port indices from the indicated ones are used to obtain a DMRS port index qᵢ via the application of a linear or a non-linear function.
h(x₁, . . . , x_{α})=Σᵢ₌₁^{α}θᵢ·xᵢ+bᵢ where θᵢ, bᵢ≥0
h(x₁, . . . , x_{α})=Σᵢ₌₁^{α}θᵢ·g(xᵢ)+bᵢ where θᵢ, bᵢ≥0 and g may be a linear or non-linear function.

In some examples, the parameters involved in the mapping functions above (a, b, d, γ, θ, θᵢ, bᵢ) are integer values.

In some examples, the non-linear functions may comprise floor, ceiling and/or modulo (‘mod’) operations.

In a given instance of port-indication, the UE may apply different mapping functions to the set of indicated ports.

In accordance with embodiments, the communication device (e.g., the UE) is configured to
receive a DCI/SCI that schedules a physical uplink, downlink or sidelink channel comprising a field that indicates n≥1 DMRS port indices {p₀, . . . , pₙ₋₁},
determine n DMRS port indices {q₀, . . . , qₙ₋₁}, where port index qᵢ is obtained from the DCI/SCI-indicated port index pᵢ, and wherein at least one qᵢ≠pᵢ for some i∈{0, . . . , n−1}, and
use the ports {q₀, . . . , qₙ₋₁} for the transmission or reception of said physical channel.

In this case, a mix of identity mapping and at least one other mapping is performed.

Note that the phrase ‘a DCI/SCI field indicates/provides one or more antenna/DMRS port indices’ means the existence of a b-bit field (b≥1) in the DCI/SCI, wherein a bit-pattern or codepoint of the field maps to one or more DMRS/antenna port indices. In some cases, the bit-pattern or codepoint also maps to other parameters such as the number of CDM groups without data and/or the number of front-load symbols along with the port index/indices. The field(s) indicating the antenna/DMRS port indices(s) (and optionally, the number of CDM groups without data and/or the number of front-load symbols) may also be the ‘Antenna ports’ field(s) which is/are typically used to indicate DMRS parameters.

Note that the term ‘port-mapping’ in this disclosure may mean the application of an identity and/or any linear and/or non-linear mapping as described above on one or more of the port indices indicated by a DCI/SCI {p₀, . . . , pₙ₋₁} to obtain one or more port indices {q₀, . . . , qₘ₋₁}.

Any reference to a ‘method/function/mapping used for port-mapping’ in this disclosure may denote an identity or any linear or non-linear mapping including the functions h(·) described above.

In certain embodiments, the mapping function(s) to be used by the communication device (e.g., the UE) and/or one or more of the parameter(s) of the mapping function(s) (for example, the variables such as a, b, d, γ, θ, θᵢ, bᵢ and/or functions/operations such as g(·), └·┘, ┌·┐, mod described in the example mapping functions above) are indicated via the scheduling DCI/SCI or any other network node signalling via the PHY-layer (any DCI/SCI other than the scheduling one) and/or any higher layer (e.g., RRC, or MAC-CE). In some examples, the mapping function(s) and/or the parameter(s) of the mapping function(s) is/are fixed in the NR specifications and known to the UE. Port-mapping is immensely helpful in saving specification effort and offering backward compatibility by the reuse of available DCI/SCI-based port indication methods that are applicable for existing DMRS configurations (for e.g., 3GPP NR Rel. 15-17).

While the different mapping functions used are provided above, the correspondence between the DCI/SCI-indicated DMRS port indices p and the obtained DMRS port indices qᵢ, i.e., the relationship between a given i and the corresponding value(s) of j used in the port-mapping is to be discussed. The correspondence depends on various factors such as CDM group of a DCI/SCI-indicated DMRS port index pⱼ, pre-determined ordering of DMRS ports provided, required or mandated by the NR specifications, explicit indication of the correspondence, etc. Examples of some port-mapping and port index correspondence are provided in the following.

In certain embodiments, the communication device (e.g., the UE) may be indicated with a total of n≥1 DMRS port indices {p₀, . . . , pₙ₋₁} via one or more fields in a DCI/SCI, and m=n DMRS port indices {q₀, . . . , qₘ₋₁} may be obtained from the indicated n ports to be used for the transmission or reception of the physical channel by the UE, via identity, linear and/or non-linear port-mapping. In this case, a one-to-one-correspondence exists between the indicated DMRS port indices {p₀, . . . , pₙ₋₁} and the DMRS port indices {q₀, . . . , qₘ₋₁} that are used for the transmission or the reception of the physical channel by the UE, in the order of appearance, i.e., qᵢ=pᵢ or qᵢ=h(pᵢ), i=0, . . . , n−1, where h(·) is a linear or non-linear function. In another example, the correspondence between the indicated DMRS port indices {p₀, . . . , pₙ₋₁} and the DMRS port indices {q₀, . . . , qₘ₋₁} may be in the reversed order of appearance, i.e., qᵢ=pₙ₋₁₋ᵢ or qᵢ=h(pₙ₋₁₋ᵢ), i=0, . . . , n−1. In a second example, the correspondence between the indicated DMRS port indices {p₀, . . . , pₙ₋₁} and the DMRS port indices {q₀, . . . , qₘ₋₁} may be any permutation of the n positions {0, . . . , n−1}.

The decision on what type of port-mapping is used for a given position i may depend on various factors such as the CDM group of pᵢ, a fixed/predetermined set of rules provided in the NR specifications, the correspondence between the two sets of port indices, etc. A DMRS port used for the transmission or reception of the physical channel may, therefore, be the one indicated by one of the antenna port fields in the DCI/SCI, or it is determined via an application of a linear or non-linear mapping function to one or more of the indicated port indices.

Some more examples of port-mapping and correspondence of the port index positions are as follows.

Example 1: A DCI/SCI provides the port indices {p₀, . . . , pₙ} via one or more fields, where port indices {p₀, . . . , p_{n′-1}}, n′<n belong to CDM group g₀ and the port indices {p_{n′}, . . . , pₙ₋₁} belong to CDM group g₁. The UE may be configured to apply an identity mapping to the first set of port indices {p₀, . . . , p_{n′-1}} and a linear or non-linear mapping function to the second set of port indices {p_{n′}, . . . , pₙ₋₁} to obtain the n ‘mapped’ ports qᵢ with an identity correspondence between the port-index positions, i.e., qᵢ=pᵢ, i=0, . . . , n′−1 and qᵢ=h(pᵢ), i=n′, . . . , n−1.

Example 2: A DCI/SCI provides the port indices {p₀, . . . , pₙ} via one or more fields, where port indices {p₀, . . . , p_{n′-1}}, n′<n belong to CDM group g₀ and the port indices {p_{n′}, . . . , pₙ₋₁} belong to CDM group g₁. The communication device (e.g., the UE) may be configured to apply an identity mapping to the first set of port indices {p₀, . . . , p_{n′-1}}, and a linear or non-linear mapping function to the second set of port indices {p_{n′}, . . . , pₙ₋₁} to obtain the n ‘mapped’ ports q; with the correspondence between the port-indices obtained by a reversed-ordering of the port-index positions within a given CDM group, i.e., qᵢ=p_{n′-i-1}, i=0, . . . , n′−1 and qᵢ=h(p_{n+n′-i-1}), i=n′, . . . , n−1.

In some examples, the mapping function h(·) may be a linear function that maps a given port depending on the CDM group of the port: h(pᵢ)=a·pᵢ+b, where a=a₀ and b=b₀ if pᵢ belongs to CDM group g₀ and a=a₁ and b=b₁ if pᵢ belongs to CDM group g₁ and so on.

Port-Mapping with Legacy DMRS Port Indication

With port-mapping described above as a vital tool in expanding to a wider array of available DMRS ports for the transmission or reception of a physical channel, the DMRS port indication itself needs to be discussed. In a method described below, a DCI/SCI comprises a first field for DMRS port indication along with additional field(s) to aid in port-mapping of the indices provided by said first field. Two ways can be used for the realization of the above: explicit network indication of the mapping function(s) and/or mapping parameter(s), or network indication via a flag for the application of a mapping wherein the mapping function(s) and/or parameter(s) are fixed in the specification(s), i.e., known to the UE. The description of the two ways are described below.

In accordance with embodiments, the communication device (e.g., the UE) is configured to
receive a DCI or an SCI that schedules a physical uplink, downlink or sidelink shared channel, wherein the DCI/SCI comprises at least the following fields:
   a first DCI/SCI field indicating n≥1 DMRS port indices {p₀, . . . , pₙ₋₁},
   one or more additional DCI/SCI fields indicating at least one of the following used for mapping at least a subset of the indicated DMRS port indices {p₀, . . . , pₙ₋₁} to at least a subset of the m≤n DMRS port indices {q₀, . . . , qₘ₋₁} used for the transmission or reception of the physical channel:
      one or more mapping functions or one or more values that map to one or more mapping functions used for port-mapping of at least one of the ports {p₀, . . . , pₙ₋₁} to one of the ports {q₀, . . . , qₘ₋₁},
      one or more parameters or one or more values that map to parameter(s) used for a port-mapping,
      one or more ‘offset’ values or one or more values/indices that map to offset value(s) for port-mapping, and
determine at least one DMRS port index qᵢ, i∈{0, m−1} for the transmission or reception of the scheduled physical channel by using the indicated mapping function(s) and/or mapping parameter(s) and/or offset value(s), and at least one DMRS port index indicated by said first DCI/SCI field.

In this method, the specifications may provide a list of mapping function(s), parameter(s) and/or ‘offset’ value(s) for port-mapping and the additional field(s) described above may be used to choose from them, which ones(s) has/have to be applied to at least a subset of the DCI/SCI-indicated DMRS port indices.

So, when the communication device acts as a network node, the network node or gNB is configured to:
transmit, to a communication device acting as a UE, a DCI or an SCI that schedules a physical uplink, downlink or sidelink shared channel, wherein the DCI/SCI comprises at least the following fields:
   a first DCI/SCI field indicating n≥1 DMRS port indices {p₀, . . . , pₙ₋₁},
   one or more additional DCI/SCI fields indicating at least one of the following used for mapping at least a subset of the indicated DMRS port indices {p₀, . . . , pₙ₋₁} to at least a subset of the m≤n DMRS port indices {q₀, . . . , qₘ₋₁} used for the transmission or reception of the physical channel:
      one or more mapping functions or one or more values that map to one or more mapping functions used for port-mapping of at least one of the ports {p₀, . . . , pₙ₋₁} to one of the ports {q₀, . . . , qₘ₋₁},
      one or more parameters or one or more values that map to parameter(s) used for a port-mapping,
      one or more ‘offset’ values or one or more values/indices that map to offset value(s) for port-mapping,
for enabling the UE to determine at least one DMRS port index qᵢ, i∈{0, m−1} for the transmission or reception of the scheduled physical channel by using the indicated mapping function(s) and/or mapping parameter(s) and/or offset value(s), and at least one DMRS port index indicated by said first DCI/SCI field.

In accordance with embodiments, the communication device (e.g., the UE) is configured to
receive a DCI/SCI that schedules a physical uplink, downlink or sidelink shared channel wherein the DCI/SCI comprises at least the following fields:
   a first DCI/SCI field indicating n≥1 DMRS port indices {p₀, . . . , pₙ₋₁},
   one or more additional DCI/SCI fields indicating that one or more predetermined port-mapping methods and/or functions and/or ‘offset’ values (i.e., fixed in the NR specifications and/or known to the UE) shall be applied at least to a subset of antenna port indices {p₀, . . . , pₙ₋₁}, and
determine at least one DMRS port index qᵢ, i∈{0, m−1} for the transmission or reception of the scheduled physical channel by the application of said one or more predetermined port-mapping function(s) and/or mapping parameter(s) and/or offset value(s), and at least one DMRS port index indicated by said first DCI/SCI field.

The additional field(s) described in this method may indicate that a predetermined port-mapping is to be used by the communication device (e.g., the UE), i.e., the additional field(s) may act as just an enable/disable field(s) that may trigger the application of a certain fixed/predetermined port-mapping method. In a first example, a single DCI/SCI field of one bit-size indicates a predetermined port-mapping function (identity, linear or non-linear) to be applied by the communication device (e.g., the UE) at least to a subset of port(s) indicated by said first DCI/SCI field (for instance, a ‘1’ may imply that said pre-determined/fixed port-mapping method(s)/function(s)/‘offset’ value(s) are used to a subset of ports, and a ‘0’ may imply that no port mapping methods/function/‘offset’ values are applied and the identity mapping is used). In a second example, the additional field(s) may be a single DCI/SCI field of two bits, wherein a certain bit-pattern/codepoint may indicate that one or more pre-determined/fixed mapping methods/functions/‘offset’ values to be applied to one or more index/indices satisfying a certain condition (port-indices in a certain range, or belonging to a certain CDM group, etc.). For instance, a first bit pattern ‘00’ (or codepoint ‘0’) of the field may indicate the application of at least a first mapping method/function/‘offset’ value to port indices indicated by said first field in CDM group ‘e₀’ or the ones that are within the range [uₗ⁰, uₕ⁰]. A second bit pattern ‘01’ (or codepoint ‘1’) of the field may indicate the application of at least a second mapping function/method to port indices indicated by said first field in CDM group ‘e₁’ or the ones that are within the range [uₗ¹, uₕ¹] and so on. The second field is essentially an ‘enable/disable’ field for port-mapping which, in addition to just enabling, may also indicate which type/method of mapping is to be applied or which subset of ports are to be port-mapped.

The method using ‘offset’ values for the port-mapping is described in further detail below.

In accordance with embodiments, the communication device (e.g., the UE) is configured to
receive a DCI/SCI that schedules a physical uplink, downlink or sidelink shared channel, wherein the DCI/SCI comprises the following fields:
   a first DCI/SCI field that indicates n≥1 DMRS port indices {p₀, . . . , pₙ₋₁},
   one or more additional DCI/SCI fields comprising
      an explicit indication of z≥1 offset values {t₀, . . . , t_{z-1}}, or
      a flag of b≥1 bits that indicates whether one or more predetermined offset value(s) (which are fixed in the NR specifications and known to the UE) are applied to at least a subset of port indices {p₀, . . . , pₙ₋₁}, and
determine at least one DMRS port index qᵢ, i∈{0, m−1} for the transmission or reception of the scheduled channel by adding at least one of the indicated offset values tᵢ, i=0, . . . , z−1, or at least one predetermined offset value, to at least one antenna port index {p₀, . . . , pₙ₋₁}, or a scalar multiple of at least one antenna port index {p₀, . . . , pₙ₋₁}.

In this method, a port pⱼ may be mapped to a DMRS port qₛ via a linear mapping qₛ=aᵤ·pⱼ+tᵢ+c, where tᵢ is a port offset value, which can depend, in some examples, on the port index pⱼ, the DMRS configuration type, the number of front-load symbols, and/or the CDM group of port pⱼ. In some examples, the offset value tᵢ is identical for one or more port indices pⱼ. In some examples, the value of aᵤ is set to one. In some examples, the value of aᵤ is an integer non-zero value, and may depend on DMRS configuration type or the CDM group index of port pⱼ among other parameters. The value c denotes another offset value that may depend on a different set of parameters than tᵢ. In some examples, c=0 or not present in the mapping.

These conditions may be applicable both for the case of explicit offset value indication or the predetermined offset value(s) that may be fixed in the specifications.

In certain embodiments, the value of tᵢ for a port pⱼ or a CDM group may be indicated in the scheduling DCI, or via any other higher layer or PHY-layer signalling, or it is fixed in the NR specifications and hence known to the UE.

In any of the methods described in this disclosure, the DCI/SCI field(s) indicating, updating or modifying DMRS ports, port-mapping functions, port-mapping parameters, the number of CDM groups without data or the number of DMRS front-load symbols for a physical channel can be enabled or disabled via the use of reserved codepoint(s) for the field, via a different field in the same or a different DCI/SCI or via a signalling from a higher layer. In a first example, said field may have a null/dummy/reserved codepoint(s) that does not indicate any said setting, whose usage may imply the disabling of said field. For example, if the field is of size b-bits, of the 2^{b} codepoints available, at least one of them is set as a reserved codepoint, whose usage does not indicate any setting, thus ending up disabling the field. In a second example, a separate one-bit flag is provided in the DCI/SCI, or a higher layer parameter is provided, which is used to indicate whether the setting(s) indicated or updated or modified by said DCI/SCI field(s) are used for the transmission or reception of scheduled physical channel or not. With such a disabling capability, backward compatibility is fully enabled.

### Multiple DMRS Port(s) Indication Fields

Combining legacy DMRS port(s) indication with port-mapping is one of the tools that can be used to accommodate DMRS configurations with densified port allocations, as described above. A second solution for the same would be the use of multiple DMRS port(s) indication field wherein one may be used for legacy port-indication purposes while the other field(s) is/are for the added ports due to DMRS densification. The combined set of ports indicated by all the fields may be used for the transmission or reception of a physical channel.

In accordance with embodiments, the communication device (e.g., the UE) is configured to receive in a DCI or SCI, that schedules a physical uplink, downlink or sidelink shared channel, wherein the DCI/SCI comprises at least two of the following fields:
a first field that indicates n₁≥1 DMRS port index/indices {p₀¹, . . . , pₙ_{₁}₋₁⁰}, and
a second field that indicates n₂≥1 DMRS port index/indices {p₀¹, . . . , pₙ_{₂}₋₁¹},
   wherein 1≤m≤n₁+n₂ DMRS port indices {q₀, . . . , qₘ₋₁} are chosen and/or determined from the port index/indices indicated by said first and/or second fields, and are used by the communication device for the transmission or reception of the scheduled physical channel.

When a communication device acts as a network node, the network node (or gNB) is configured to is configured to transmit to a communication device acting as a UE, a DCI or SCI, that schedules a physical uplink, downlink or sidelink shared channel, wherein the DCI/SCI comprises at least two of the following fields:
a first field that indicates n₁≥1 DMRS port index/indices {p₀⁰, . . . , pₙ_{₁}₋₁⁰}, and
a second field that indicates n₂≥1 DMRS port index/indices {p₀¹, . . . , pₙ_{₂}₋₁¹},
   wherein 1≤m≤n₁+n₂ DMRS port indices {q₀, . . . , qₘ₋₁} are chosen and/or determined from the port index/indices indicated by said first and/or second fields, and are used by the UE for the transmission or reception of the scheduled physical channel.

The correspondence between the indicated ports {p₀⁰, . . . , pₙ_{₁}₋₁⁰, p₀¹, . . . , pₙ_{₂}₋₁¹} and the port indices {q₀, . . . , qₘ₋₁}, i.e., the correspondence between a value of j∈{0, . . . , m−1} (the ‘mapped’ ports may be denoted as qⱼ) and the value(s) of position(s) of the indicated port(s) i∈{0, . . . , n₁−1} or i∈{0, . . . , n₂−1} and/or the indicating field ϕ∈{0, 1} (the indicated ports may be denoted as pᵢ^{ϕ}) may be one-to-one or many-to-one.

In certain embodiments, a DMRS port index qᵢ, i∈{0, . . . , m−1} used for the transmission or reception of a physical channel is determined from one or more DMRS port indices indicated by the first antenna port field, the second antenna port field, or the first and the second antenna port fields via an identity mapping, a linear mapping or a nonlinear mapping.

In certain embodiments, for the identity mapping, a port index pⱼ provided by a field in the DCI/SCI is directly mapped to port index qᵢ, i.e., qᵢ=pⱼ^{ϕ}, i∈{0, . . . , m−1}, and j∈{0, . . . , n₁−1} if ϕ=0, and j∈{0, . . . , n₂−1} if ϕ=1. Only one-to-one correspondence is applicable in the case of identity mapping. As mentioned before, an identity mapping is the same as choosing one of the indicated port indices to be used as a port index for the transmission of said physical channel.

In certain embodiments, for the linear or non-linear mapping, one or more port indices {pⱼ_{₀}^{ϕ}^{₀}, . . . pⱼ_{_{α-1}}^{ϕ}^{_{α−1}}} (α≥1 with jᵤ∈{0, . . . , n₁−1} if ϕᵤ=0 and jᵤ∈{0, . . . , n₂−1} if ϕᵤ=1, for u=0, . . . α−1 and jᵤ≠j_{u′} if u≠u′) indicated by the first, second, or first and second DMRS/antenna port(s) indication field(s) in the DCI/SCI are mapped to a port index qᵢ via a linear or non-linear function h(·), i.e., qᵢ=h(pⱼ_{₀}^{ϕ}^{₀}, . . . pⱼ_{_{α−1}}^{ϕ}^{_{α−1}}), i∈{0, . . . , m−1}. The possible linear and/or non-linear mapping functions for different values of a are provided above.

In a variation of the above method, the use of one of the DMRS fields as such (identity mapping to ports used for the transmission or reception of the physical channel) and the other with a linear or non-linear port-mapping is provided below.

In accordance with embodiments, the communication device (e.g., the UE) is configured to receive in a DCI or SCI, that schedules a physical uplink, downlink or sidelink shared channel, wherein the DCI/SCI comprises at least two of the following fields:
a first field that indicates n₁≥1 DMRS port index/indices {p₀⁰, . . . , pₙ_{₁}₋₁⁰}, and
a second field that indicates n₂≥1 DMRS port index/indices {p₀¹, . . . , pₙ_{₂}₋₁¹},
   wherein a total of m=n₁+n₂ DMRS port indices {q₀, . . . , qₘ₋₁} are used for the transmission or reception of the scheduled physical channel wherein qᵢ=pᵢ⁰, i=0, . . . n₁−1 and qᵢ=h(pᵢ₋ₙ_{₁}¹), i=n1, . . . , m−1 where h(·) is a linear or a non-linear function.

The ports indicated by the first field are used such without any port-mapping. Hence, this may correspond to a DMRS port indication field from existing DMRS configurations, for e.g., a port indication field from 3GPP NR releases 15-17. The ports indicated by the second field are port-mapped using a linear or a non-linear function and hence they could be the ports added due to port-densification or any other enhancements to the DMRS configuration associated with said first field. By separating the DMRS ports indication corresponding to the various configurations (or the same configuration but associated with various releases or enhancements), backward compatibility or co-existence of the DMRS configuration and dynamic switching between them may be achieved. Moreover, by dynamically enabling or disabling the second field via the use of reserved codepoint(s) for the field, using other DCI/SCI signalling or higher layer signalling adds further flexibility to the feature.

In accordance with embodiments, the communication device (e.g., the UE) is configured to receive a DCI/SCI with a field that indicates DMRS port indices wherein the field comprises at least one reserved/null/dummy codepoint that does not indicate any DMRS port indices.

In accordance with embodiments, the communication device (e.g., the UE) is configured to receive via the physical layer or a higher layer an indication whether one or more of the DMRS/Antenna port indication fields in the DCI/SCI is to be used for the transmission or reception of a physical channel or not, i.e., a signalling whether one or more of the DCI/SCI fields indicating DMRS/Antenna port(s) is/are enabled or disabled for the transmission or reception of a scheduled physical channel. For example, a field in the DCI scheduling said physical channel or a different DCI may provide such an indication. In a second example, a MAC-CE message or RRC signalling may provide such an indication.

### Modification of Other DMRS Parameters

With an increase in the number of DMRS ports per CDM group due to port densification, the required number of symbols for orthogonalization for a given set of ports and the number of CDM groups without data may be modified to suit the densified set of ports. The DMRS/antenna ports indication via a DCI/SCI typically provides multiple parameters at once. And similar to port-mapping that updates port indices, update of the other parameters is considered in the following.

In accordance with embodiments, the communication device (e.g., the UE) is configured to receive a DCI/SCI that schedules a physical uplink, downlink or sidelink shared channel, wherein the DCI/SCI comprises
a first field that provides or indicates at least two of the following:
   n≥1 DMRS port indices {p₀, . . . , pₙ₋₁},
   the number of CDM groups without data d,
   the number of front-load DMRS symbols f, and
one or more additional fields providing at least one of the following:
   an indication associated with port-mapping that provides port-mapping parameter(s)/method(s)/function(s) to be applied to one or more port indices {p₀, . . . , pₙ₋₁}, or indicates the application of one or more pre-determined/fixed port-mapping methods/functions/parameters to one or more of the port indices {p₀, . . . , pₙ₋₁},
   an indication of or a mapping to an updated value d′ for the number of CDM groups without data, d, or the difference between the updated value d′ and d, e.g., d′−d or d−d′, wherein d′ may be identical or different to d,
   an indication of or a mapping to an updated value f′ for the number of front-load DMRS symbols, f, or the difference between the updated value f′ and f, e.g., f′−f or f−f′, wherein f′ is identical or different to f, and wherein,
      the communication device (e.g., the UE) is configured to use m≤n DMRS port indices determined using the indicated port-mapping indications provided in said one or more additional fields or using pre-determined port-mapping method(s), d′ CDM groups without data and/or f′ front-load DMRS symbols for the transmission or reception of said physical channel.

In the above method, the DMRS ports indication field in the DCI/SCI provides a set of DMRS parameters according to an existing DMRS configuration and DCI/SCI field, and the provided parameters are updated by other fields to account for newer DMRS configurations with densified ports.

Hence, when the communication device acts as a network node, the communication device, is configured to: transmit to a communication device acting as a UE, a DCI/SCI that schedules a physical uplink, downlink or sidelink shared channel, wherein the DCI/SCI comprises
a first field that provides or indicates at least two of the following:
   n≥1 DMRS port indices {p₀, . . . , pₙ₋₁},
   the number of CDM groups without data d,
   the number of front-load DMRS symbols f, and
one or more additional fields providing at least one of the following:
   an indication associated with port-mapping that provides port-mapping parameter(s)/method(s)/function(s) to be applied to one or more port indices {p₀, . . . , pₙ₋₁}, or indicates the application of one or more pre-determined/fixed port-mapping methods/functions/parameters to one or more of the port indices {p₀, . . . , pₙ₋₁},
   an indication of or a mapping to an updated value d′ for the number of CDM groups without data, d, or the difference between the updated value d′ and d, e.g., d′−d or d−d′, wherein d′ may be identical or different to d,
   an indication of or a mapping to an updated value f′ for the number of front-load DMRS symbols, f, or the difference between the updated value f′ and f. e.g., f′−f or f−f′, wherein f′ is identical or different to f, and wherein,
      the UE is configured to use m≤n DMRS port indices determined using the indicated port-mapping indications provided in said one or more additional fields or using pre-determined port-mapping method(s), d′ CDM groups without data and/or f′ front-load DMRS symbols for the transmission or reception of said physical channel.

In the following, the individual modification of the aforementioned parameters is discussed. A decoupling of the updates of the DMRS parameters provides a higher flexibility to the scheduler.

In accordance with embodiments, the communication device (e.g., the UE) is configured to receive a DCI/SCI signalling and/or higher layer signalling that indicates that the number of front-load DMRS symbols for a physical channel is decreased by a value of 1 or left unchanged. In certain embodiments, the decrease, or a lack of change in the value may be pre-determined (i.e., fixed in the specifications) depending on the CDM groups of the ports indicated and the port-indices that the indicated ports are mapped to. This behaviour may additionally be enabled by said signalling. For example, if after a port-mapping, if the final set of DMRS ports for the physical channel belong to the same CDM group and can be orthogonalized with just one symbol, the setting of the number of front-load DMRS symbols to 1 can be performed. Otherwise, the value may be unchanged. This behaviour may be enabled by, for instance, a single-bit field in the DCI/SCI when set to ‘1’ or the configuration of a higher layer parameter. When the field is set to a value of ‘0’ or if the higher layer parameter is not configured, no change to the number of front-load symbols is made.

When a higher number of ports per CDM group are available due to port densification, in instances where the number of CDM groups without data indicated is higher than the number of CDM groups present or required, the UE may be indicated to rate-match around fewer number of CDM groups than indicated to increase throughput for a given number of multi-layer transmissions.

In accordance with embodiments, the communication device (e.g., the UE) is configured to receive a DCI/SCI signalling and/or a higher layer signalling that indicates a decrease, an increase or no change in the value of the number of CDM groups without data indicated for a physical channel. In certain embodiments, the decrease, increase or a lack of change in the value may be pre-determined (i.e., fixed in the specifications) depending on the CDM groups of the ports indicated and the port-indices ultimately used for the transmission or reception of the physical channel. This behaviour may additionally be enabled by said signalling. For instance, a single bit field can be included in the DCI/SCI or a higher layer parameter can be included for this purpose. If the DCI/SCI field is set to ‘1’ (or ‘0’) or the higher layer parameter is configured, the UE may perform a pre-determined change (fixed in the specifications) in the value of the number of CDM groups without data depending on the DMRS ports indicated and the CDM groups of the final set of port-indices used for the transmission or reception of said physical channel. For instance, if the initial set of indicated ports are from 2 CDM groups and following a port-mapping the final set of ports are from just 1 CDM group, the number of CDM groups without data is decreased by a value of 1. If there is no change in the number of CDM groups of the indicated ports and the final set of ports after port-mapping, there may be no change in the number of CDM groups without data. If the DCI/SCI field is set to ‘0’ (or ‘1’), no change is made in the value of the number of CDM groups without data.

In accordance with embodiments, the communication device (e.g., the UE) is configured to perform at least one of the following for the transmission or reception of a physical UL/DL/SL channel scheduled by a DCI/SCI:
the number of CDM groups without data to be used for said physical channel is reduced or increased at least by a value of 1 from the value indicated in at least one of the DCI/SCI field(s),
the number of front-load DMRS symbols to be used for said physical channel is reduced by a value of 1 from the value indicated in at least one of the DCI/SCI field(s).

This behaviour may be fixed in the specifications and may be performed by the communication device (e.g., the UE) when at least one of the following occurs:
A mapping of at least one of the port-indices indicated by a DMRS/Antenna port indication field in said DCI/SCI to a different port index than the one indicated is performed for the transmission or reception of said physical channel.
There is more than one field in said DCI/SCI indicating DMRS ports or there is a field providing a mapping of at least one DMRS/Antenna port index indicated in the DCI/SCI to a different port index.
The number of CDM groups among the port-indices indicated via the DCI/SCI for said physical channel is higher than the number of CDM groups among the port-indices that are used for the transmission or reception of said physical channel (which may be obtained after a port-mapping of the port indices indicated via the DCI/SCI).
The port-indices indicated via the DCI/SCI can be orthogonalized with at least 2 front-loaded DMRS symbols while the port-indices after port-mapping of said indicated port-indices can be orthogonalized with 1 front-loaded DMRS symbol.

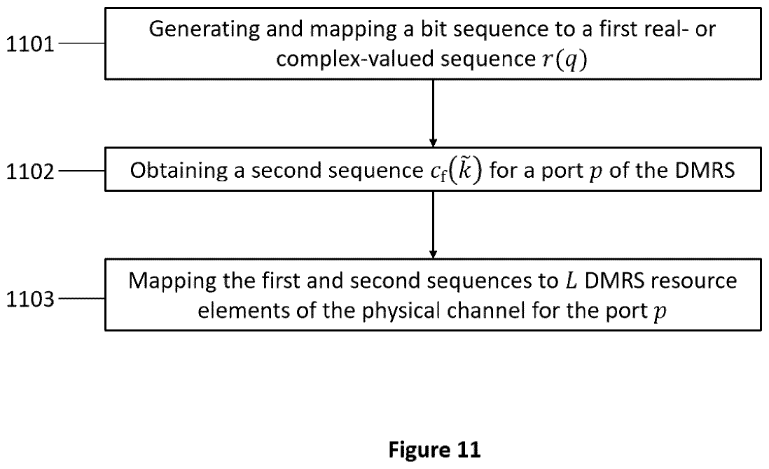

Referring to FIG. 11 there is illustrated a flowchart of a method for generating a DMRS, the method being performed by a communication device. According to some example embodiments, such a method may include the following main steps. At 1101, the method may include generating and mapping a bit sequence to a first real- or complex-valued sequence r(q). In some example embodiments, the indexing q is expressed as a linear combination of a first index/variable and a second index/variable in which said both first and second indices are integer valued and non-negative. In some example embodiments, the sequence r(q) comprises at least L entries.

At 1102, the method may also include obtaining a second sequence c_{f}(\tilde{k}) for a port p of the DMRS. In some example embodiments, the second sequence c_{f}(\tilde{k}) may be defined such that second sequence c_{f}(\tilde{k}) is an L-length sequence, where \tilde{k}=0, 1, . . . , L−1. In some example embodiments, the second sequence c_{f}(\tilde{k}) may comprise unit-magnitude entries that are real- or complex-valued and \tilde{k} is an indexing variable. According to the some example embodiments, the second sequence c_{f}(\tilde{k}) may comprise at least one of a column or a row of a Discrete Fourier Transform (DFT)-based matrix such as a DFT matrix or an Inverse DFT matrix of size L×L, a column or a row of a Discrete Cosine Transform (DCT)-based matrix of size L×L, a column or a row of a Hadamard matrix of size L×L, or a column or a row of any other orthogonal or unitary matrix of size L×L.

At 1103, the method may include mapping the first and second sequences to L DMRS resource elements of the physical channel for the port p. According to some example embodiments, the mapping of the first and second sequences may comprise multiplying L entries of the first sequence r(q), element-by-element, with the L entries of the second sequence c_{f}(\tilde{k}) for the port p to obtain a resulting real- or complex-valued symbol (or real- or complex-valued baseband amplitude) sequence d(i), and mapping the resulting real- or complex-valued symbol (or the real- or complex-valued baseband amplitude) sequence d(i) to a subset of L DMRS resource elements for the port p from a set of resource elements associated with the DMRS in one or more physical resource blocks (PRBs) of the physical channel. Accordingly, the subset of L DMRS resource elements associated with the port p can all be present in a single PRB or in at least two different PRBs. In some example embodiments, the DMRS resource elements may be associated with at least two different values of the first index, and can be present in one physical resource block (PRB) or across multiple PRBs associated with the physical channel.

As previously described and according to some embodiments, the indexing of the first sequence r(q) is expressed as q=θ·n+φ·k′ wherein θ and φ are scalars that are non-negative integers, n and k′ are said first and second indices/integer variables respectively.

Additional embodiments of the method performed by the communication device have been presented. As previously described, the communication device may be a UE or a network node (or gNB).

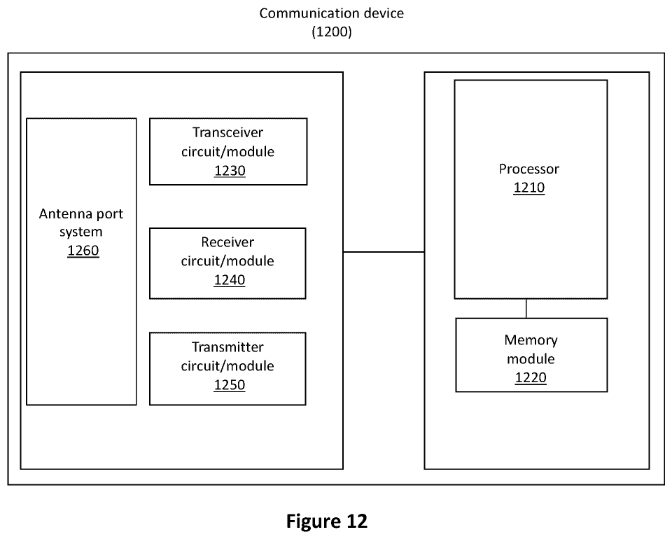

In order to perform the previously described process or method steps and previously described embodiments, there is provided a communication device. FIG. 12 illustrates a block diagram depicting a communication device 1200. The communication device 1200 comprises a processor 1210 or processing circuit or a processing module or a processor or means for processing; a receiver circuit or receiver module 1240; a transmitter circuit or transmitter module 1250; a memory module 1220, a transceiver circuit or transceiver module 1230 which may include the transmitter circuit 1250 and the receiver circuit 1240. The communication device 1200 further comprises an antenna system 1260 which includes antenna circuitry for transmitting and receiving signals, the antenna system may employ beamforming.

The communication device 1200 may belong to any radio access technology including 4G or LTE, LTE-A, 5G, etc. that support beamforming technology. The communication device comprising the processor 1210 and the memory 1220 which contains instructions executable by the processor 1210, whereby the communication device is operative/configured to perform any one of the subject-matter of previously described embodiments.

The communication device 1200 is configured to or is operative to: generate and map a bit sequence to a first real- or complex-valued sequence r(q), wherein, the indexing q is expressed as a linear combination of a first index/variable and a second index/variable in which said both first and second indices are integer valued and non-negative, and the sequence r(q) comprises at least L entries. The communication device is further configured to generate a second L-length sequence, c_{f}(\tilde{k}), for a port p of the DMRS comprising unit-magnitude entries that are real- or complex-valued; and map the first and second sequences to a subset of L DMRS resource elements of the physical channel for said port p, wherein the DMRS resource elements are associated with at least two different values of said first index, and are present in one physical resource block (PRB) or across multiple PRBs associated with the physical channel.

The indexing of the first sequence r(q) is expressed as q=θ·n+φ·k′ wherein θ and φ are scalars that are non-negative integers, n and k′ are said first and second indices/integer variables, respectively.

At a communication device 1200 acting as a UE, the DMRS generation method is performed for the DMRS associated with one of the following channels: a PUSCH, a PUCCH or a PRACH (physical random-access channel).

At a communication device 1200 acting as a network node, the DMRS generation method is performed for the DMRS associated with one of the following channels: a PDSCH, a PDCCH or a PBCH (physical broadcast channel).

Additional functions or operations performed by the communication device have already been described and need not be repeated.

The processing module/circuit of the communication device 1200 includes a processor, microprocessor, an application specific integrated circuit (ASIC), field programmable gate array (FPGA), or the like, and may be referred to as the “processor.” The processor controls the operation of the communication device 1200 and its components. Memory (circuit or module) includes a random access memory (RAM), a read only memory (ROM), and/or another type of memory to store data and instructions that may be used by processor. In general, it will be understood that the communication device in one or more embodiments includes fixed or programmed circuitry that is configured to carry out the operations in any of the embodiments disclosed herein.

There is also provided a computer program comprising instructions which when executed by the processor of the communication device 1200 cause the processor 1210 to carry out the example methods described herein, including the method described with respect to flowchart of FIG. 11.

The communication device 1200, when acting as a UE, is configured to perform the DMRS generation method according to example embodiments described herein, including being configured to operate in association with the method described with respect to flowchart of FIG. 11. In some example embodiments, a DMRS generation method is associated with a physical control, shared, or random-access channels.

The communication device 1200, when acting as a network node, is configured to perform the method described with respect to flowchart of FIG. 11. According to some example embodiments, a DMRS generation method is associated with a physical control, shared, or broadcast channel.

In at least one such example, the communication device 1200 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure. Further, it will be appreciated that the communication device may comprise additional components.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation.

As described, the embodiments herein may be applied in any wireless systems including LTE or 4G, LTE-A (or LTE-Advanced), 5G, WiMAX, WiFi, satellite communications, TV broadcasting etc. that may employ beamforming technology.

1-32. (canceled)

33. A method, performed by a communication device, for generating a demodulation reference signal (DMRS) comprising one or more ports for a physical channel, the method comprising:
generating and mapping a bit sequence to a first sequence r(q), the first sequence being a real- or complex-valued sequence;
obtaining a second sequence c_{f}(\tilde{k}), where \tilde{k}=0, 1, . . . , L−1 for a port p of the DMRS, the second sequence being at least one of the following:
a column or a row of a Discrete Fourier Transform (DFT)-based matrix such as a DFT matrix or an Inverse DFT matrix of size L×L;
a column or a row of a Discrete Cosine Transform (DCT)-based matrix of size L×L;
a column or a row of a Hadamard matrix of size L×L; or
a column or a row of any other orthogonal or unitary matrix of size L×L;
mapping the first and second sequences to L DMRS resource elements of the physical channel for port p which comprises:
multiplying L entries of the first sequence r(q), element-by-element, with the L entries of the second sequence c_{f}(\tilde{k}) for the port p to obtain a resulting real- or complex-valued symbol (or real- or complex-valued baseband amplitude) sequence d(i); and
mapping the resulting real- or complex-valued symbol (or the real- or complex-valued baseband amplitude) sequence d(i) to a subset of L DMRS resource elements for the port p from a set of resource elements associated with the DMRS in one or more physical resource blocks (PRBs) of the physical channel, wherein the subset of L DMRS resource elements associated with the port p are all present in a single PRB or in at least two different PRBs.

34. The method according to claim 33, wherein an indexing of the first sequence r(q) is expressed as φ=θ·n+φ·k′, wherein:
θ and φ are scalars that are non-negative integers, and
n and k′ are first and second indices/integer variables, respectively.

35. The method according to claim 33, wherein the generating of the bit sequence comprises:
computing at least a subset of values corresponding to the bit sequence based on fixed/specified rule(s) provided in specification(s), or
obtaining/retrieving at least a subset of values corresponding to the bit sequence provided directly in the specification(s).

36. The method according to claim 33, wherein the subset of L DMRS resource elements are:
a subset of DMRS resource elements associated with the DMRS in one or more PRBs of the physical channel, or
the set of all DMRS resource elements associated with the DMRS in one or more PRBs of the physical channel.

37. The method according to claim 34, wherein, for a given subset of L DMRS resource elements, among the L values of k for the second sequence c_{f}(\tilde{k}), at least two values of the L values of \tilde{k} for the second sequence are mapped to or associated with at least two different DMRS resource elements that are associated with at least two different values of n.

38. The method according to claim 33, wherein the mapping of the second sequence c_{f}(\tilde{k}) to the L DMRS resource elements is repeated for multiple different disjoint subsets of DMRS resource elements in a DMRS port.

39. The method according to claim 33, wherein the subset of L DMRS resource elements for the port p are present in at least two different PRBs;
wherein at least one resource element from the subset of L DMRS resource elements for the port p is present in a first PRB and at least one other resource element from the subset of L DMRS resource elements for the port p is present in a PRB other than the first PRB.

40. The method according to claim 33, wherein the total number of PRBs comprising the DMRS in the physical channel N_{RB} is an integer multiple of N_{c}_{_{f}}_{(\tilde{k})}^{RB} which is a smallest number of PRBs in which the mapping of the second sequence c_{f}(\tilde{k}) is repeated to U≥1 disjoint subsets of the DMRS resource elements of the PRBs, wherein each disjoint subset has L DMRS resource elements and a union of the disjoint subsets is equal to a set of all DMRS resource elements in the PRBs.

41. The method according to claim 33, wherein L is 4, 6, or 8.

42. The method according to claim 33, wherein, when a total number of DMRS resource elements associated with a port (or CDM group) in a PRB N_{DMRS}^{RB} is equal to 6, the number of PRBs scheduled for the DMRS or the physical channel is an even number.

43. The method according to claim 34, wherein the L DMRS resource elements comprise g≥2 segments with v≥1 resource elements per segment and each segment is associated with a different value of n and each resource element belongs to only one segment.

44. The method according to claim 43, wherein at least one of the following applies:
K′=v, where k′=0, . . . , K′−1 with K′≥1 and K′ is a total number of resource elements per segment;
g=L/K′;
θ=K′; or
φ=1.

45. The method according to claim 33, wherein the mapping of the first and second sequences to the L DMRS resource elements is performed using the first sequence r(q) and the second sequence c_{f}(\tilde{k}) as:
$${a}_{k , l}^{( p , μ )} = {β}_{DMRS} \cdot {w}_{t} ( {l}^{′} ) \cdot {c}_{f} ( \tilde{k} ) \cdot r ( q )$$
with φ=θ·n+k′, k, l, p and μ denoting a resource element index, a symbol index, a port index, and waveform numerology, respectively, and
$$k = \{ \begin{matrix}4 n + 2 {k}^{′} + Δ & Configuration type {T}_{1} \\ 6 n + {k}^{′} + Δ & Configuration type {T}_{2}\end{matrix} {k}^{′} = 0 , … , {K}^{′} - 1 l = \overline{l} + {l}^{′} {l}^{′} = 0 , … , Z - 1 n = 0 , 1 , …$$
where K′ is a total number of resource elements per segment, the variable l̅ is associated with the symbol index l and is configured by a network node or is defined in wireless standards specification(s), the value Δ is a subcarrier offset index within a specific PRB that depends on a code-division-multiplexing (CDM) group index λ for the port p, β_{DMRS} is a positive, non-zero value, and wₜ(l′) is a complex- or real-valued sequence.

46. The method according to claim 45, wherein the value \tilde{k}, used in the second sequence c_{f}(\tilde{k}) for the mapping, is computed using at least one of the following indices/parameters: k, k′, N_{sc}^{RB}, N_{DMRS}^{RB}, n, Δ, L, where N_{sc}^{RB} is a total number of subcarriers associated with a port (or CDM group) in a PRB.

47. The method according to claim 46, wherein the value of \tilde{k} to be used for a resource element is computed by one of the following:
$$\tilde{k} = \frac{mod ( k - Δ , {N}_{sc}^{R B} )}{2} , \tilde{k} = mod ( 2 n + {k}^{′} , {N}_{DMRS}^{R B} ) , \tilde{k} = mod ( mod ( k - Δ , {N}_{sc}^{R B} ) , {N}_{DMRS}^{R B} ) , or \\ \tilde{k} = mod ( 2 n + {k}^{′} , L ) .$$

48. The method according to claim 45, wherein the value of \tilde{k} for a resource element is given by
$$\tilde{k} = {k}^{′} + mod ( mod ( ⌊ \frac{2 n + {k}^{′}}{{K}^{′} \cdot {N}_{sep}} ⌋ , {N}_{{c}_{f} ( \tilde{k} )}^{( n )} ) \cdot {K}^{′} , L ) ,$$
where:
Nₛₑₚ represents a difference between two closest values of n that the first sequence is mapped to, and
N_{c}_{_{f}}_{(\tilde{k})}⁽ⁿ⁾ is a smallest number of consecutive values of n across which the second sequence c_{f}(\tilde{k}) is mapped, wherein the mapping of the second sequence is repeated to U≥1 disjoint subsets of associated DMRS resource elements with L DMRS resource elements in each subset and a union of the subsets is equal to a set of all DMRS resource elements associated with the values of n, and where K′≥1.

49. A method, performed by a communication device, for receiving a physical channel with a demodulation reference signal (DMRS), the DMRS comprising one or more ports, the method comprising processing the received physical channel with the DMRS;
wherein the DMRS for the physical channel is generated by:
generating and mapping a bit sequence to a first sequence r(q), the first sequence being a real- or complex-valued sequence; and
obtaining a second sequence c_{f}(\tilde{k}), where \tilde{k}=0, 1, . . . , L−1 for a port p of the DMRS, the second sequence c_{f}(\tilde{k}) being at least one of the following:
a column or a row of a Discrete Fourier Transform (DFT)-based matrix such as a DFT matrix or an Inverse DFT matrix of size L×L;
a column or a row of a Discrete Cosine Transform (DCT)-based matrix of size L×L;
a column or a row of a Hadamard matrix of size L×L; or
a column or a row of any other orthogonal or unitary matrix of size L×L; and
wherein the DMRS for the physical channel is generated by mapping the first and second sequences to L DMRS resource elements of the physical channel for the port p, which comprises:
multiplying L entries of the first sequence r(q), element-by-element, with the L entries of the second sequence c_{f}(\tilde{k}) for the port p to obtain a resulting real- or complex-valued symbol (or the real- or complex-valued baseband amplitude) sequence d(i); and
mapping the resulting real- or complex-valued symbol (or the real- or complex-valued baseband amplitude) sequence d(i) to a subset of L DMRS resource elements for the port p from a set of resource elements associated with the DMRS in one or more physical resource blocks (PRBs) of the physical channel, wherein the subset of L DMRS resource elements associated with the port p are all present in a single PRB or in at least two different PRBs.

50. A communication device for generating a demodulation reference signal (DMRS) comprising one or more ports for a physical channel, the communication device comprising a processor and a memory containing instructions executable by the processor, whereby the communication device is configured to:
generate and map a bit sequence to a first sequence r(q), the first sequence being a real- or complex-valued sequence;
obtain a second sequence c_{f}(\tilde{k}), where k=0, 1, . . . , L−1 for a port p of the DMRS, the second sequence being at least one of the following:
a column or a row of a Discrete Fourier Transform (DFT)-based matrix such as a DFT matrix or an Inverse DFT matrix of size L×L;
a column or a row of a Discrete Cosine Transform (DCT)-based matrix of size L×L;
a column or a row of a Hadamard matrix of size L×L; or
a column or a row of any other orthogonal or unitary matrix of size L×L; and
map the first and second sequences to L DMRS resource elements of the physical channel for the port p, which comprises being configured to:
multiply L entries of the first sequence r(q), element-by-element, with the L entries of the second sequence c_{f}(\tilde{k}) for the port p to obtain a resulting real- or complex-valued symbol (or the real- or complex-valued baseband amplitude) sequence d(i); and
map the resulting real- or complex-valued symbol (or the real- or complex-valued baseband amplitude) sequence d(i) to a subset of L DMRS resource elements for port p from a set of resource elements associated with the DMRS in one or more physical resource blocks (PRBs) of the physical channel, wherein the subset of L DMRS resource elements associated with the port p are all present in a single PRB or in at least two different PRBs.

51. The communication device according to claim 50, wherein the communication device is a user equipment (UE).

52. The communication device according to claim 50, wherein the communication device is a network node or gNB.
